(19) United States
(12) Patent Application Publication
(10) Pub. No.: US 2026/0273702 A1
(43) Pub. Date: Sep. 17, 2026

(54) REMOTE MANIPULATION APPARATUS, COUPLING TOOL, KIT INCLUDING COUPLING TOOL AND SECOND COUPLING TOOL, AND METHOD OF USING REMOTE MANIPULATION APPARATUS

(71) Applicant: NAGAKI SEIKI CO., LTD., Osaka (JP)

(72) Inventors: Takashi MIYAKO, Wakabayashi-ku, Sendai-shi, Miyagi (JP); Keitarou OBA, Miyagi (JP); Junji TANAKA, Osaka (JP); Masayuki ISHIGAKI, Osaka (JP); Masanori GOTO, Osaka (JP)

(21) Appl. No.: 19/167,101

(22) PCT Filed: Mar. 15, 2024
(86) PCT No.: PCT/JP2024/010155

§ 371 Date: Sep. 19, 2025

(30) Foreign Application Priority Data
Mar. 20, 2023 (JP) 2023-043972

(51) Int. Cl. B25B 7/22; B25B 7/12; H02G 1/02

(52) U.S. Cl. CPC B25B 7/22; B25B 7/12; H02G 1/02

(57) ABSTRACT

An object is to provide a remote manipulation apparatus. The remote manipulation apparatus includes: tool having first acting member and second acting member; the first manipulation rod coupled to the first acting member; the second manipulation rod coupled to the second acting member; a manipulation member that remotely manipulates at least one of the first acting member and the second acting member; and a coupling tool that couples the first manipulation rod and the second manipulation rod. The coupling tool includes a first receiving part that receives a part of the first manipulation rod, a second receiving part that receives a part of the second manipulation rod, and a first coupling part that couples the first receiving part and the second receiving part. The second receiving part allows the second manipulation rod to move in the lateral direction relative to the second inner face of the second receiving part.

### TECHNICAL FIELD

The present invention relates to a remote manipulation apparatus, a coupling tool, a kit including a coupling tool and a second coupling tool, and a method of using a remote manipulation apparatus.

### BACKGROUND ART

Operation apparatuses for remote manipulation that can grip a target such as an overhead electrical wire are known.

As a related art, Patent Literature 1 discloses an operation apparatus for remote manipulation. The operation apparatus for remote manipulation disclosed in Patent Literature 1 includes a distal end operation tool, a primary manipulation rod, an auxiliary manipulation rod, a manipulation handle, and a coupling holding tool arranged at respective middle parts of the primary manipulation rod and the auxiliary manipulation rod and coupling the primary manipulation rod and the auxiliary manipulation rod to each other. Further, the coupling holding tool has a first holding member, a second holding member, and a coupling member. The coupling holding tool is fixed to the primary manipulation rod with the first holding member and the coupling member holding the primary manipulation rod from both sides and is fixed to the auxiliary manipulation rod with the second holding member and the coupling member holding the auxiliary manipulation rod from both sides.

### CITATION LIST

### Patent Literature

Patent Literature 1: Japanese Patent Application Laid-Open No. 2010-82780

### SUMMARY OF INVENTION

### Technical Problem

In the operation apparatus for remote manipulation disclosed in Patent Literature 1, the coupling holding tool couples the primary manipulation rod and the auxiliary manipulation rod to each other and thereby suppresses bending of the primary manipulation rod during use of the operation apparatus for remote manipulation. In the operation apparatus for remote manipulation disclosed in Patent Literature 1, the primary manipulation rod is held by the first holding member, and the auxiliary manipulation rod is held by the second holding member. Further, in the operation apparatus for remote manipulation disclosed in Patent Literature 1, the coupling member is pivotable with respect to the first holding member or the second holding member, and thereby relative motion of the primary manipulation rod with respect to the auxiliary manipulation rod is smoothly performed. However, the range in which the relative motion is available is restricted by a range in which pivot movement of the coupling member relative to the first holding member or the second holding member is available. Thus, for some sizes or the like of an operating target to be gripped or cut by the distal end operation tool, smooth relative motion of the primary manipulation rod with respect to the auxiliary manipulation rod may be prevented.

Accordingly, an object of the present invention is to provide a remote manipulation apparatus, a coupling tool, a kit including a coupling tool and a second coupling tool, and a method of using a remote manipulation apparatus in which bending of the first manipulation rod and the second manipulation rod is suppressed and smooth relative motion of the second manipulation rod with respect to the first manipulation rod is allowed.

### Solution to Problem

The present invention relates to a remote manipulation apparatus, a coupling tool, a kit including a coupling tool and a second coupling tool, and a method of using a remote manipulation apparatus illustrated below.
(1) A remote manipulation apparatus including:
   a tool having a first acting member and a second acting member and configured to grip or cut a target by the first acting member and the second acting member;
   a first manipulation rod coupled to the first acting member;
   a second manipulation rod coupled to the second acting member;
   a manipulation member coupled to the first manipulation rod and the second manipulation rod, respectively, and configured to remotely manipulate at least one of the first acting member and the second acting member by relative motion of the second manipulation rod with respect to the first manipulation rod; and
   a coupling tool configured to couple the first manipulation rod and the second manipulation rod to each other in a region between the tool and the manipulation member,
   wherein the coupling tool includes
   a first receiving part having a first inner face that holds the first manipulation rod and defining a first region that receives a part of the first manipulation rod,
   a second receiving part having a second inner face that is able to come into contact with the second manipulation rod, defining a second region that receives a part of the second manipulation rod, and configured to allow the second manipulation rod to move in a lateral direction relative to the second inner face in the second region, and
   a first coupling part configured to couple the first receiving part and the second receiving part to each other.
(2) The remote manipulation apparatus according to (1) above, wherein in a state where the coupling tool is attached to the first manipulation rod and the second manipulation rod, the coupling tool is slidingly movable with respect to the first manipulation rod along the longitudinal direction of the first manipulation rod.
(3) The remote manipulation apparatus according to (1) above,
   wherein when a direction from the first receiving part to the second receiving part is defined as a first lateral direction, and a direction from the second receiving part to the first receiving part is defined as a second lateral direction, the second inner face of the second receiving part includes
   a first abutment face arranged on the first lateral direction side of the second region and configured to prevent an increase in a gap between the first manipulation rod and the second manipulation rod, and
   a second abutment face arranged on the second lateral direction side of the second region and configured to prevent a reduction in the gap between the first manipulation rod and the second manipulation rod, and
   wherein the second region between the first abutment face and the second abutment face allows the increase in the gap between the first manipulation rod and the second manipulation rod and the reduction in the gap between the first manipulation rod and the second manipulation rod.
(4) The remote manipulation apparatus according to (2) above,
   wherein when a direction from the first receiving part to the second receiving part is defined as a first lateral direction, and a direction from the second receiving part to the first receiving part is defined as a second lateral direction, the second inner face of the second receiving part includes
   a first abutment face arranged on the first lateral direction side of the second region and configured to prevent an increase in a gap between the first manipulation rod and the second manipulation rod, and
   a second abutment face arranged on the second lateral direction side of the second region and configured to prevent a reduction in the gap between the first manipulation rod and the second manipulation rod, and
   wherein the second region between the first abutment face and the second abutment face allows the increase in the gap between the first manipulation rod and the second manipulation rod and the reduction in the gap between the first manipulation rod and the second manipulation rod.
(5) The remote manipulation apparatus according to any one of (1) to (4) above, wherein the first region and the second region differ in shape or size from each other.
(6) The remote manipulation apparatus according to (5) above, wherein the second region has an elongated shape longer in the lateral direction when viewed in a direction along the longitudinal direction of the second manipulation rod.
(7) The remote manipulation apparatus according to any one of (1) to (4) above further including a second coupling tool configured to couple the first manipulation rod and the second manipulation rod to each other in a region between the tool and the coupling tool,
   wherein the second coupling tool includes
   a third receiving part having a third inner face that holds the first manipulation rod and defining a third region that receives a part of the first manipulation rod,
   a fourth receiving part having a fourth inner face that is able to come into contact with the second manipulation rod, defining a fourth region that receives a part of the second manipulation rod, and configured to allow the second manipulation rod to move in the lateral direction relative to the fourth inner face in the fourth region, and
   a second coupling part that couples the third receiving part and the fourth receiving part to each other, and
   wherein the length of the second coupling part is shorter than the length of the first coupling part.
(8) A coupling tool configured to couple a first manipulation rod of a remote manipulation apparatus and a second manipulation rod of the remote manipulation apparatus to each other to suppress bending of the first manipulation rod and the second manipulation rod, the coupling tool including:
   a first receiving part having a first inner face that is able to hold the first manipulation rod and defining a first region that receives a part of the first manipulation rod;
   a second receiving part having a second inner face that is able to come into contact with the second manipulation rod, defining a second region that receives a part of the second manipulation rod, and configured to allow the second manipulation rod to move in a lateral direction relative to the second inner face in the second region; and
   a first coupling part that couples the first receiving part and the second receiving part to each other.
(9) The coupling tool according to (8) above, wherein the first coupling part
   couples the first receiving part and the second receiving part to each other so that the distance between the first receiving part and the second receiving part is changeable,
   couples the first receiving part and the second receiving part to each other so that relative rotation between the first receiving part and the second receiving part is allowed, or
   couples the first receiving part and the second receiving part to each other so that the distance between the first receiving part and the second receiving part is changeable and relative rotation between the first receiving part and the second receiving part is allowed.
(10) A kit including:
   the coupling tool according to (8) or (9) above; and
   a second coupling tool,
   wherein the second coupling tool includes
   a third receiving part having a third inner face that is able to hold the first manipulation rod and defining a third region that receives a part of the first manipulation rod,
   a fourth receiving part having a fourth inner face that is able to come into contact with the second manipulation rod, defining a fourth region that receives a part of the second manipulation rod, and configured to allow the second manipulation rod to move in the lateral direction relative to the fourth inner face in the fourth region, and
   a second coupling part that couples the third receiving part and the fourth receiving part to each other, and
   wherein the length of the first coupling part and the length of the second coupling part differ from each other, or at least one of the length of the first coupling part and the length of the second coupling part is adjustable.
(11) A method of using a remote manipulation apparatus,
   wherein the remote manipulation apparatus includes
   a tool having a first acting member and a second acting member and configured to grip or cut a target by the first acting member and the second acting member,
   a first manipulation rod coupled to the first acting member,
   a second manipulation rod coupled to the second acting member,
   a manipulation member coupled to the first manipulation rod and the second manipulation rod, respectively, and configured to remotely manipulate at least one of the first acting member and the second acting member by relative motion of the second manipulation rod with respect to the first manipulation rod, and
   a coupling tool configured to couple the first manipulation rod and the second manipulation rod to each other in a region between the tool and the manipulation member,
   wherein the coupling tool includes
   a first receiving part having a first inner face that holds the first manipulation rod and defining a first region that receives a part of the first manipulation rod,
   a second receiving part having a second inner face that is able to come into contact with the second manipulation rod and defining a second region that receives a part of the second manipulation rod, and
   a first coupling part that couples the first receiving part and the second receiving part to each other,
   the method including steps of:
   manipulating the manipulation member so that the second manipulation rod moves relative to the first manipulation rod;
   applying gripping force or cutting force to the target from the first acting member and the second acting member by relative motion of the second manipulation rod with respect to the first manipulation rod; and
   laterally moving the second manipulation rod relative to the second inner face in the second region defined by the second receiving part in response to the relative motion of the second manipulation rod with respect to the first manipulation rod.

### Advantageous Effects of Invention

According to the present invention, it is possible to provide a remote manipulation apparatus, a coupling tool, a kit including a coupling tool and a second coupling tool, and a method of using a remote manipulation apparatus in which bending of the first manipulation rod and the second manipulation rod is suppressed and smooth relative motion of the second manipulation rod with respect to the first manipulation rod is allowed.

### BRIEF DESCRIPTION OF DRAWINGS

FIG. 1 represents general side views schematically illustrating a state before a coupling tool is attached to manipulation rods of a remote manipulation apparatus of a first embodiment.

FIG. 2 represents general side views schematically illustrating the remote manipulation apparatus of the first embodiment.

FIG. 3 is a general perspective view schematically illustrating an example of a coupling tool.

FIG. 4 represents general sectional views schematically illustrating an example of the coupling tool.

FIG. 5 represents general side views schematically illustrating a remote manipulation apparatus of a second embodiment.

FIG. 6 represents diagrams schematically illustrating a view in which the coupling tool is slidingly movable in the longitudinal direction of the first manipulation rod.

FIG. 7 represents diagrams schematically illustrating a view in which at least one of the first manipulation rod and the second manipulation rod is bent and deformed.

FIG. 8 is a general sectional view schematically illustrating an example of the coupling tool.

FIG. 9 represents diagrams schematically illustrating a state where a plurality of coupling tools are attached to the first manipulation rod and the second manipulation rod.

FIG. 10 represents general sectional views schematically illustrating an example of a second coupling tool.

FIG. 11 represents general enlarged side views illustrating an example of a manipulation member.

FIG. 12 is a general three-side view schematically illustrating a coupling tool of a third embodiment.

FIG. 13 represents diagrams schematically illustrating a coupling tool of a first modified example of the third embodiment and a coupling tool of a second modified example of the third embodiment.

FIG. 14 represents diagrams schematically illustrating a coupling tool of a third modified example of the third embodiment and a coupling tool of a fourth modified example of the third embodiment.

FIG. 15 represents diagrams schematically illustrating an example of a kit including a coupling tool and a second coupling tool of a fourth embodiment.

FIG. 16 represents diagrams schematically illustrating another example of the kit including the coupling tool and the second coupling tool of the fourth embodiment.

FIG. 17 is a flowchart illustrating an example of a method of using the remote manipulation apparatus of the embodiment.

### DESCRIPTION OF EMBODIMENTS

A remote manipulation apparatus 1, a coupling tool 6, a kit K including the coupling tool 6 and a second coupling tool 8, and a method of using the remote manipulation apparatus 1 of the embodiment will be described below in detail with reference to the drawings. Note that, in the present specification, members having the same type of functions are labeled with the same or similar references. Further, for the members labeled with the same or similar references, duplicated description thereof may be omitted.

### Definition of Direction

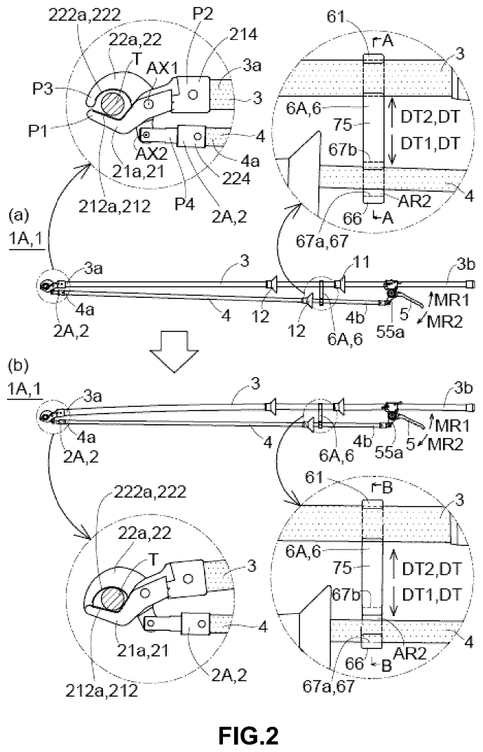

As recognized from FIG. 2 and the like, in the present specification, the direction from a first receiving part 61 of the coupling tool 6 to a second receiving part 66 of the coupling tool 6 is defined as “first lateral direction DT1”, and the direction from the second receiving part 66 of the coupling tool 6 to the first receiving part 61 of the coupling tool 6 is defined as “second lateral direction DT2”. Further, the first lateral direction DT1 and the second lateral direction DT2 are collectively referred to as “lateral direction DT”. In other words, the lateral direction DT encompasses the first lateral direction DT1 and the second lateral direction DT2. In a state where the first manipulation rod 3 is received in the first receiving part 61 and the second manipulation rod 4 is received in the second receiving part 66, the direction from the first manipulation rod 3 to the second manipulation rod 4 matches “first lateral direction DT1”, and the direction from the second manipulation rod 4 to the first manipulation rod 3 matches “second lateral direction DT2”.

### First Embodiment

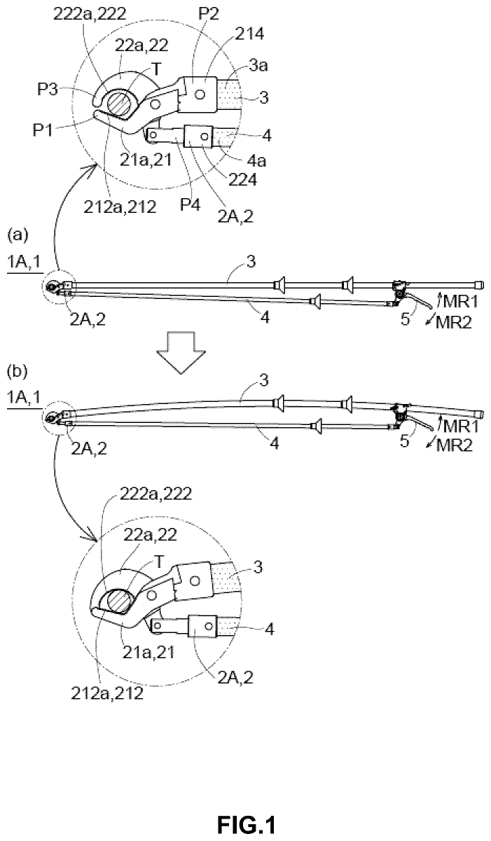

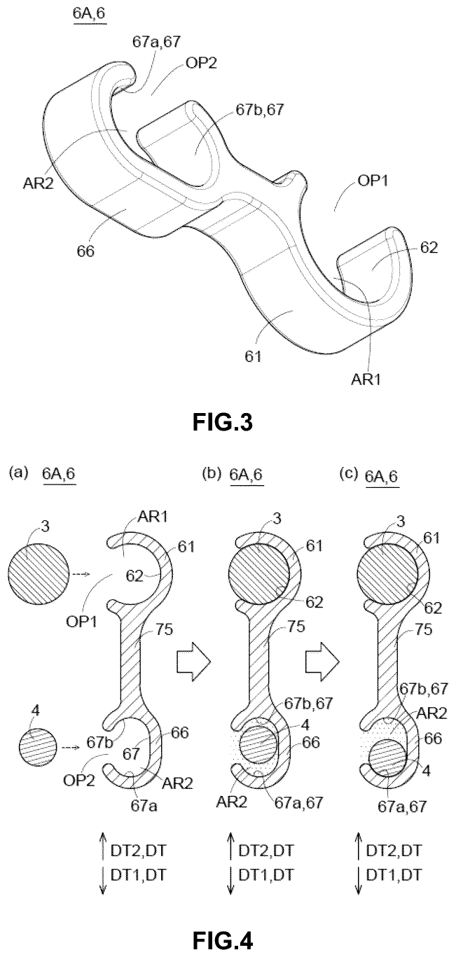

A remote manipulation apparatus 1A of the first embodiment will be described with reference to FIG. 1 to FIG. 4. FIG. 1 represents general side views schematically illustrating a state before a coupling tool 6A is attached to manipulation rods (3, 4) of the remote manipulation apparatus 1A of the first embodiment. FIG. 2 represents general side views schematically illustrating the remote manipulation apparatus 1A of the first embodiment. In this specification, illustration (a) in FIG. 1 may be referred to as FIG. 1(a), and illustration (b) in FIG. 1 may be referred to as FIG. 1(b). In this specification, illustration (a) in FIG. 2 may be referred to as FIG. 2(a), and illustration (b) in FIG. 2 may be referred to as FIG. 2(b). Note that FIG. 1(a) and FIG. 2(a) illustrate a state before a target T is gripped by the remote manipulation apparatus 1A, and FIG. 1(b) and FIG. 2(b) illustrate a state after the target T is gripped by the remote manipulation apparatus 1A. FIG. 3 is a general perspective view schematically illustrating an example of the coupling tool 6A. In this specification, illustration (a) in FIG. 4 may be referred to as FIG. 4(a), illustration (b) in FIG. 4 may be referred to as FIG. 4(b) and illustration (c) in FIG. 4 may be referred to as FIG. 4(c). FIG. 4 represents general sectional views schematically illustrating an example of the coupling tool 6A. Note that FIG. 4(a) illustrates a state before the coupling tool 6A is attached to the first manipulation rod 3 and the second manipulation rod 4, FIG. 4(b) illustrates an arrow A-A sectional view in FIG. 2(a), and FIG. 4(c) illustrates an arrow B-B sectional view in FIG. 2(b).

The remote manipulation apparatus 1A of the first embodiment includes a tool 2, the first manipulation rod 3, the second manipulation rod 4, a manipulation member 5, and the coupling tool 6A (see FIG. 2(a)).

In the example illustrated in FIG. 1(a), the tool 2 is a gripping tool 2A that can grip the target T by a first acting member 21 and a second acting member 22. The tool 2 has the first acting member 21 and the second acting member 22. The first acting member 21 has a first acting part 212 that comes into contact with the target T, and the second acting member 22 has a second acting part 222 that comes into contact with the target T.

As illustrated in FIG. 1(a) as an example, when the tool 2 is the gripping tool 2A, the first acting member 21 is a first gripping member 21a, and the first acting part 212 is a first gripping part 212a. Further, the second acting member 22 is a second gripping member 22a, and the second acting part 222 is a second gripping part 222a.

The first manipulation rod 3 is coupled to the first acting member 21, and the second manipulation rod 4 is coupled to the second acting member 22. In the example illustrated in FIG. 1(a), a distal end 3a of the first manipulation rod 3 is coupled to a proximal end 214 of the first acting member 21, and a distal end 4a of the second manipulation rod 4 is coupled to a proximal end 224 of the second acting member 22.

The manipulation member 5 is coupled to the first manipulation rod 3 and the second manipulation rod 4, respectively. Further, the manipulation member 5 moves the second manipulation rod 4 relative to the first manipulation rod 3 and thereby remotely manipulates at least one of the first acting member 21 and the second acting member 22. Note that moving the second manipulation rod 4 relative to the first manipulation rod 3 may be performed by moving the second manipulation rod 4, may be performed by moving the first manipulation rod 3, or may be performed by moving both the first manipulation rod 3 and the second manipulation rod 4.

In the example illustrated in FIG. 1(a), when the manipulation member 5 is manipulated in a first manipulation direction MR1, the distance between the first acting part 212 and the second acting part 222 is reduced, and the target T is gripped by the first acting member 21 and the second acting member 22 (see FIG. 1(b)). On the other hand, when the manipulation member 5 is manipulated in a second manipulation direction MR2, the distance between the first acting part 212 and the second acting part 222 is increased, and the gripping of the target T by the first acting member 21 and the second acting member 22 is released (see FIG. 1(a)).

As illustrated in FIG. 1(b) as an example, when the manipulation member 5 is manipulated in the first manipulation direction MR1 in a state where the target T is in contact with the first acting part 212 and the second acting part 222, at least one of the first manipulation rod 3 and the second manipulation rod 4 is bent. This bending reduces the gripping force acting on the target T. Further, due to repeated significant bending of the manipulation rods (3, 4), the manipulation rods (3, 4) may be deteriorated. For example, the shape of the manipulation rod (3, 4) may fail to return to the default shape illustrated in FIG. 1(a), or the manipulation rod (3, 4) may be broken.

Accordingly, as illustrated in FIG. 2(a) as an example, the remote manipulation apparatus 1A of the first embodiment includes the coupling tool 6A that suppresses bending of the first manipulation rod 3 and the second manipulation rod 4.

The coupling tool 6A couples the first manipulation rod 3 and the second manipulation rod 4 to each other in the region between the tool 2 and the manipulation member 5. The coupling tool 6A includes the first receiving part 61 that receives a part of the first manipulation rod 3 (in other words, a long portion of the first manipulation rod 3), a second receiving part 66 that receives a part of the second manipulation rod 4 (in other words, a long portion of the second manipulation rod 4), and a first coupling part 75 that couples the first receiving part 61 and the second receiving part 66 to each other.

As illustrated in FIG. 3 as an example, the first receiving part 61 has a first side opening OP1 through which the first manipulation rod 3 can pass, and the second receiving part 66 has a second side opening OP2 through which the second manipulation rod 4 can pass. When the first receiving part 61 has the first side opening OP1, it is possible to attach the first receiving part 61 to the first manipulation rod 3 quickly at a single touch (in other words, in a single step). Further, when the second receiving part 66 has the second side opening OP2, it is possible to attach the second receiving part 66 to the second manipulation rod 4 quickly at a single touch (in other words, in a single step).

Note that, in the first embodiment, the first side opening OP1 or the second side opening OP2 may be omitted. For example, when the coupling tool 6A has a first half and a second half, the first half and the second half may be arranged so as to hold the first manipulation rod 3 and the second manipulation rod 4 therebetween, and the first half and the second half may then be coupled to each other. In such a way, the coupling tool 6A having the first half and the second half can be attached to the first manipulation rod 3 and the second manipulation rod 4. In terms of quick attachment, however, it is more preferable that the first receiving part 61 have the first side opening OP1 and the second receiving part 66 have the second side opening OP2.

As illustrated in FIG. 4(b) and FIG. 4(c) as an example, the first receiving part 61 has the first inner face 62 that holds the first manipulation rod 3. As illustrated in FIG. 4(a) as an example, the first receiving part 61 defines the first region AR1 that receives a part of the first manipulation rod 3 (in other words, a long portion of the first manipulation rod 3). In the example illustrated in FIG. 4(a), the first region AR1 is defined by the first inner face 62 of the first receiving part 61. More specifically, the region inside the first inner face 62 of the first receiving part 61 is the first region AR1.

As illustrated in FIG. 4(a) as an example, the second receiving part 66 has a second inner face 67 that can come into contact with the second manipulation rod 4. The second receiving part 66 defines a second region AR2 that receives a part of the second manipulation rod 4 (in other words, a long portion of the second manipulation rod 4). In the example illustrated in FIG. 4(a), the second region AR2 is defined by the second inner face 67 of the second receiving part 66. More specifically, the region inside the second inner face 67 of the second receiving part 66 is the second region AR2.

In the example illustrated in FIG. 4(b), the second region AR2 (see the region provided with dotted hatching) receives the entire transverse cross section of the second manipulation rod 4 (in other words, the cross section perpendicular to the longitudinal direction of the second manipulation rod 4).

As illustrated in FIG. 4(b) and FIG. 4(c) as an example, the second region AR2 allows the second manipulation rod 4 to move in the lateral direction DT relative to the second inner face 67. For example, in the example illustrated in FIG. 2(a), when the manipulation member 5 is manipulated in the first manipulation direction MR1, the second manipulation rod 4 is displaced in a direction from the distal end 4a to the proximal end 4b due to pivoting of the arm 55a and displaced in the lateral direction DT (more specifically, the first lateral direction DT1) (see FIG. 2(b)). Since the second region AR2 described above allows displacement in the lateral direction DT of the second manipulation rod 4, the second manipulation rod 4 can smoothly move relative to the first manipulation rod 3.

Further, in the example illustrated in FIG. 2(b), because manipulation force acts on the manipulation member 5, and reaction force from the target T acts on the first acting member 21 and the second acting member 22, the first manipulation rod 3 is bent in the lateral direction DT (for example, the second lateral direction DT2). Due to this bending, the coupling tool 6A is displaced in the lateral direction DT (for example, the second lateral direction DT2) relative to the second manipulation rod 4. Since the second region AR2 described above allows relative displacement in the lateral direction DT of the coupling tool 6A with respect to the second manipulation rod 4, smooth relative motion of the second manipulation rod 4 with respect to the first manipulation rod 3 is not prevented due to the bending of the first manipulation rod 3. Further, the movable range of the manipulation member 5 is not reduced due to the bending of the first manipulation rod 3.

In contrast, when the first manipulation rod 3 is held by the first receiving part 61 so as to be unable to move laterally and the second manipulation rod 4 is held by the second receiving part 66 so as to be unable to move laterally, friction force acting between the first receiving part 61 and the first manipulation rod 3 increases and friction force acting between the second receiving part 66 and the second manipulation rod 4 increases in response to at least one of the first manipulation rod 3 and the second manipulation rod 4 being relatively displaced in the lateral direction DT or otherwise bent in the lateral direction DT. As a result, smooth relative motion of the second manipulation rod 4 with respect to the first manipulation rod 3 is prevented, and the movable range of the manipulation member 5 is reduced. Further, forcible manipulation of the manipulation member 5 against the increased friction force may damage the surfaces of the first manipulation rod 3 and the second manipulation rod 4 due to the friction.

In contrast, in the example illustrated in FIG. 4(b) and FIG. 4(c), it is possible to delay the time the second manipulation rod 4 comes into contact with a first abutment face 67a on the first lateral direction DT1 side of the second inner face 67 after manipulation of the manipulation member 5. Because of this delayed time, only a low friction force is needed that acts between the receiving parts (61, 66) and the manipulation rods (3, 4) during manipulation of the manipulation member 5. Further, the surfaces of the first manipulation rod 3 and the second manipulation rod 4 are suppressed from being damaged by the friction.

Further, in the example illustrated in FIG. 2(a), when the attached position of the coupling tool 6A is closer to the distal end (3a, 4a) side, the initial position of the second manipulation rod 4 can be positioned more distant from a first abutment face 67a on the first lateral direction DT1 side. As a result, the time the second manipulation rod 4 comes into contact with the first abutment face 67a can be further delayed, and the friction force acting between the receiving parts (61, 66) and the manipulation rods (3, 4) can be further reduced during manipulation of the manipulation member 5.

The remote manipulation apparatus 1A of the first embodiment includes the coupling tool 6A connecting the first manipulation rod 3 and the second manipulation rod 4 to each other, and the second region AR2 defined by the second receiving part 66 of this coupling tool 6A allows the second manipulation rod 4 to move in the lateral direction DT relative to the second inner face 67. Thus, bending of the first manipulation rod 3 and the second manipulation rod 4 is suppressed by the coupling tool 6A, and smooth relative motion of the second manipulation rod 4 with respect to the first manipulation rod 3 is allowed by the second region AR2.

### Second Embodiment

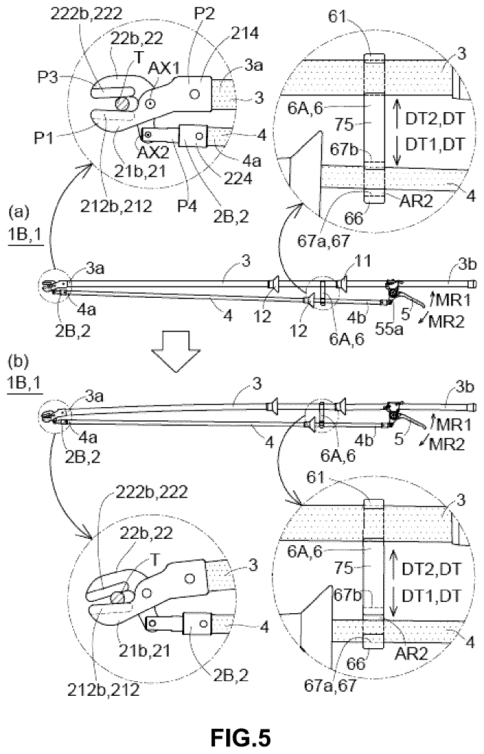

A remote manipulation apparatus 1B of a second embodiment will be described with reference to FIG. 5. FIG. 5 represents general side views schematically illustrating a remote manipulation apparatus 1B of the second embodiment. In this specification, illustration (a) in FIG. 5 may be referred to as FIG. 5(a), and illustration (b) in FIG. 5 may be referred to as FIG. 5(b). Note that FIG. 5(a) illustrates a state before the target T is cut by the remote manipulation apparatus 1B, and FIG. 5(b) illustrates a state when the target T is being cut by the remote manipulation apparatus 1B.

The remote manipulation apparatus 1B of the second embodiment differs from the remote manipulation apparatus 1A of the first embodiment in that the tool 2 is a cutting tool 2B. The second embodiment is substantially the same as the first embodiment for other respects.

In the second embodiment, features different from the first embodiment will be mainly described, and duplicated description for features that have already been described in the first embodiment will be omitted. It is therefore obvious that, even when not explicitly described in the second embodiment, the features that have already been described in the first embodiment can be employed in the second embodiment.

The remote manipulation apparatus 1B of the second embodiment includes the tool 2, the first manipulation rod 3, the second manipulation rod 4, the manipulation member 5, and the coupling tool 6A.

In the example illustrated in FIG. 5(a), the tool 2 is the cutting tool 2B that can cut the target T by the first acting member 21 and the second acting member 22. The tool 2 has the first acting member 21 and the second acting member 22. The first acting member 21 has the first acting part 212 that comes into contact with the target T, and the second acting member 22 has the second acting part 222 that comes into contact with the target T.

As illustrated in FIG. 5(a) as an example, when the tool 2 is the cutting tool 2B, the first acting member 21 is a first cutting member 21b, and the first acting part 212 is a first cutting blade 212b. Further, the second acting member 22 is a second cutting member 22b, and the second acting part 222 is a second cutting blade 222b.

The first manipulation rod 3 is coupled to the first acting member 21, and the second manipulation rod 4 is coupled to the second acting member 22. In the example illustrated in FIG. 5(a), the distal end 3a of the first manipulation rod 3 is coupled to the proximal end 214 of the first acting member 21, and the distal end 4a of the second manipulation rod 4 is coupled to the proximal end 224 of the second acting member 22.

The manipulation member 5 is coupled to the first manipulation rod 3 and the second manipulation rod 4, respectively. Further, the manipulation member 5 moves the second manipulation rod 4 relative to the first manipulation rod 3 and thereby remotely manipulates at least one of the first acting member 21 and the second acting member 22. Note that moving the second manipulation rod 4 relative to the first manipulation rod 3 may be performed by moving the second manipulation rod 4, may be performed by moving the first manipulation rod 3, or may be performed by moving both the first manipulation rod 3 and the second manipulation rod 4.

In the example illustrated in FIG. 5(a), when the manipulation member 5 is manipulated in the first manipulation direction MR1, the distance between the first acting part 212 and the second acting part 222 is reduced, and the target T is cut by the first acting member 21 and the second acting member 22 (see FIG. 5(b)). On the other hand, when the manipulation member 5 is manipulated in the second manipulation direction MR2, the distance between the first acting part 212 and the second acting part 222 is increased, and the first acting member 21 and the second acting member 22 return to the original position (see FIG. 5(a)).

The coupling tool 6A couples the first manipulation rod 3 and the second manipulation rod 4 to each other in the region between the tool 2 and the manipulation member 5. The coupling tool 6A includes the first receiving part 61 that receives a part of the first manipulation rod 3 (in other words, a long portion of the first manipulation rod 3), a second receiving part 66 that receives the second manipulation rod 4 (in other words, a long portion of the second manipulation rod 4), and the first coupling part 75 that couples the first receiving part 61 and the second receiving part 66 to each other.

The coupling tool 6A of the remote manipulation apparatus 1B of the second embodiment is substantially the same as the coupling tool 6A of the remote manipulation apparatus 1A of the first embodiment. Thus, the description of the coupling tool 6A of the first embodiment applies for the description of the coupling tool 6A, and duplicated description of the coupling tool 6A will be omitted.

The remote manipulation apparatus 1B of the second embodiment achieves the same advantageous effects as the remote manipulation apparatus 1A of the first embodiment.

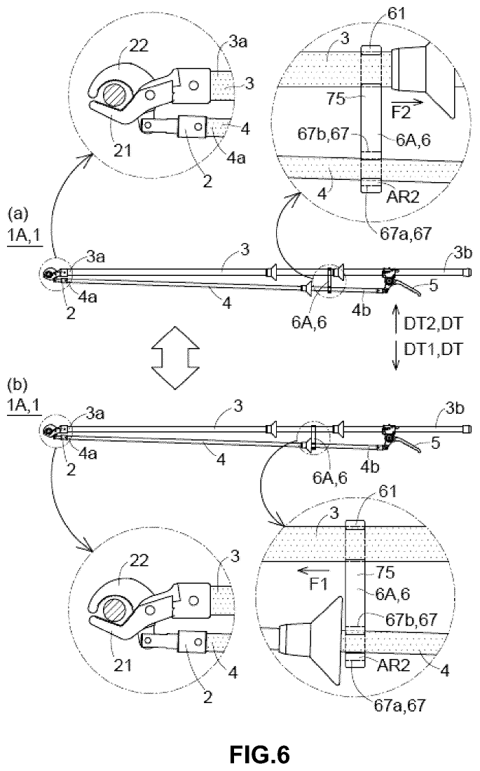

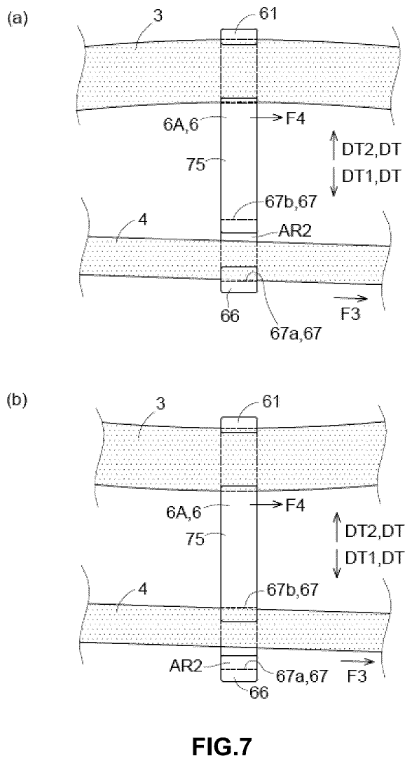

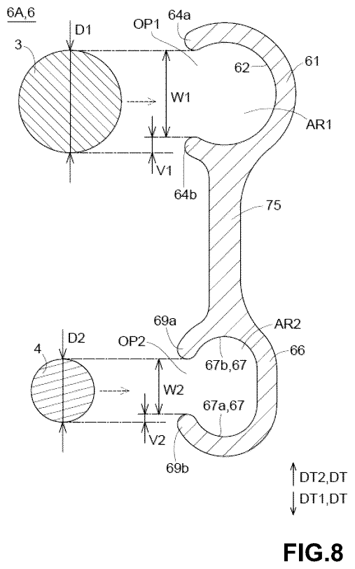

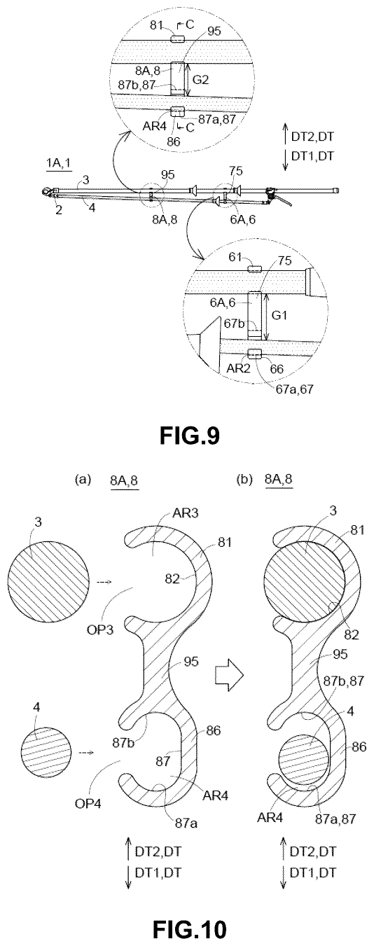

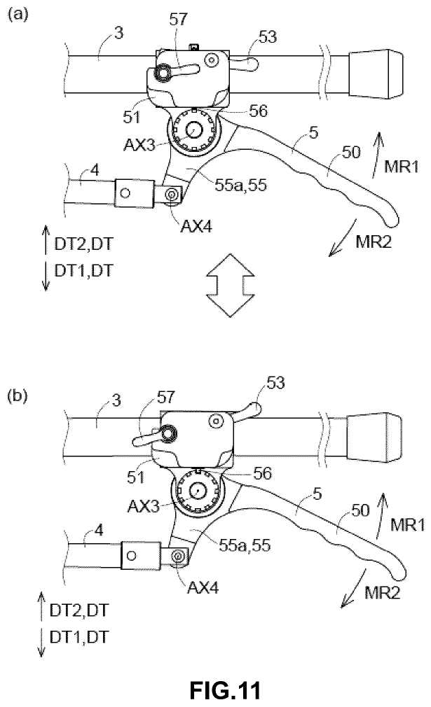

Next, optional, additional configurations that can be employed in the remote manipulation apparatus 1A of the first embodiment or the remote manipulation apparatus 1B of the second embodiment will be described with reference to FIG. 1 to FIG. 11. FIG. 6 represents diagrams schematically illustrating a view in which the coupling tool 6 is slidingly movable in the longitudinal direction of the first manipulation rod 3. In this specification, illustration (a) in FIG. 6 may be referred to as FIG. 6(a), and illustration (b) in FIG. 6 may be referred to as FIG. 6(b). FIG. 7 represents diagrams schematically illustrating a view in which at least one of the first manipulation rod 3 and the second manipulation rod 4 is bent and deformed. In this specification, illustration (a) in FIG. 7 may be referred to as FIG. 7(a), and illustration (b) in FIG. 7 may be referred to as FIG. 7(b). Note that FIG. 7(a) illustrates a view in which at least one of the first manipulation rod 3 and the second manipulation rod 4 is bent in an outward bending direction, and FIG. 7(b) illustrates a view in which at least one of the first manipulation rod 3 and the second manipulation rod 4 is bent in an inward bending direction. FIG. 8 is a general sectional view schematically illustrating an example of the coupling tool 6A. FIG. 9 represents diagrams schematically illustrating a state where a plurality of coupling tools (6, 8) are attached to the first manipulation rod 3 and the second manipulation rod 4. FIG. 10 represents general sectional views schematically illustrating an example of a second coupling tool 8A. In this specification, illustration (a) in FIG. 10 may be referred to as FIG. 10(a), and illustration (b) in FIG. 10 may be referred to as FIG. 10(b). FIG. 10(a) illustrates a state before the second coupling tool 8A is attached to the first manipulation rod 3 and the second manipulation rod 4, and FIG. 10(b) illustrates an arrow C-C sectional view in FIG. 9. FIG. 11 represents general enlarged side views illustrating an example of the manipulation member 5. In this specification, illustration (a) in FIG. 11 may be referred to as FIG. 11(a), and illustration (b) in FIG. 11 may be referred to as FIG. 11(b). Note that FIG. 11(a) illustrates a state before the manipulation member 5 is manipulated in the first manipulation direction MR1, and FIG. 11(b) illustrates a state after the manipulation member 5 has been manipulated in the first manipulation direction MR1.

### (Coupling Tool 6A)

For the coupling tool 6A, optional, additional configurations will be described. Note that optional, additional configurations for the coupling tool 6A can be employed not only in the first embodiment or the second embodiment but also in the coupling tool 6 of the third embodiment described later or the coupling tool 6 of the kit K of the fourth embodiment.

In the example illustrated in FIG. 6(a) and FIG. 6(b), in a state where the coupling tool 6A is attached to the first manipulation rod 3 and the second manipulation rod 4, the coupling tool 6A is slidingly movable with respect to the first manipulation rod 3 along the longitudinal direction of the first manipulation rod 3.

As illustrated in FIG. 6(b) as an example, it is possible to move the position of the first abutment face 67a on the first lateral direction DT1 side to a position more distant from the second manipulation rod 4 by slidingly moving the coupling tool 6A toward the distal end 3a of the first manipulation rod 3 along the first manipulation rod 3 (see the arrow F1). Thus, the time the second manipulation rod 4 abuts against the first abutment face 67a on the first lateral direction DT1 side can be further delayed when the gap between the first manipulation rod 3 and the second manipulation rod 4 is increased by manipulation of the manipulation member 5. As a result, the second manipulation rod 4 can be smoothly moved relative to the first manipulation rod 3.

In contrast, as illustrated in FIG. 6(a) as an example, it is possible to move the position of the first abutment face 67a on the first lateral direction DT1 side to a position closer to the position of the second manipulation rod 4 by slidingly moving the coupling tool 6A toward the proximal end 3b of the first manipulation rod 3 along the first manipulation rod 3 (see the arrow F2). Thus, the time the second manipulation rod 4 abuts against the first abutment face 67a on the first lateral direction DT1 side can be made earlier when the gap between the first manipulation rod 3 and the second manipulation rod 4 is increased by manipulation of the manipulation member 5. As a result, bending of the first manipulation rod 3 in the direction away from the second manipulation rod 4 (otherwise, bending of the second manipulation rod 4 in the direction away from the first manipulation rod 3) is suppressed earlier.

FIG. 2(b) illustrates an example in which one of the first manipulation rod 3 and the second manipulation rod 4 is bent in the direction away from the other of the first manipulation rod 3 and the second manipulation rod 4 (hereafter, referred to as “outward bending direction”) by manipulation of the manipulation member 5. On the other hand, one of the first manipulation rod 3 and the second manipulation rod 4 may be bent in the direction closer to the other of the first manipulation rod 3 and the second manipulation rod 4 (hereafter, referred to as “inward bending direction”) by manipulation of the manipulation member 5 (see FIG. 7(b)) in accordance with particular sizes of the target T, particular arrangement of the coupling tool 6A, particular arrangement of the second coupling tool 8A described later, particular structure and arrangement of a mechanism that transfers manipulation force from the manipulation member 5 to the first manipulation rod 3 or the second manipulation rod 4, or the like.

In contrast, in the example illustrated in FIG. 4(b), the second inner face 67 of the second receiving part 66 includes the first abutment face 67a, which suppresses the first manipulation rod 3 and the second manipulation rod 4 from bending in the outward bending direction, and a second abutment face 67b, which suppresses the first manipulation rod 3 and the second manipulation rod 4 from bending in the inward bending direction. More specifically, the first abutment face 67a is arranged on the first lateral direction DT1 side of the second region AR2 and prevents an increase of the gap between the first manipulation rod 3 and the second manipulation rod 4 by the contact with the second manipulation rod 4 (see FIG. 7(a)). In such a way, the first manipulation rod 3 and the second manipulation rod 4 are prevented from being excessively bent in the outward bending direction. Further, the second abutment face 67b is arranged on the second lateral direction DT2 side of the second region AR2 and prevents a reduction of the gap between the first manipulation rod 3 and the second manipulation rod 4 by the contact with the second manipulation rod 4 (see FIG. 7(b)). In such a way, the first manipulation rod 3 and the second manipulation rod 4 are prevented from being excessively bent in the inward bending direction.

In addition, in the example illustrated in FIG. 4(b), the second region AR2 between the first abutment face 67a and the second abutment face 67b allows an increase in the gap between the first manipulation rod 3 and the second manipulation rod 4 and a reduction in the gap between the first manipulation rod 3 and the second manipulation rod 4. In other words, the second region AR2 allows moderate bending of the first manipulation rod 3 and the second manipulation rod 4.

As discussed above, the coupling tool 6A allows both moderate bending in the outward bending direction of the manipulation rods (3, 4) and moderate bending in the inward bending direction of the manipulation rods (3, 4) and thereby ensures smooth relative motion of the second manipulation rod 4 with respect to the first manipulation rod 3. Further, the coupling tool 6A prevents both excessive bending in the outward bending direction of the manipulation rods (3, 4) and excessive bending in the inward bending direction of the manipulation rods (3, 4). As a result of excessive bending being prevented, a reduction in gripping force or cutting force acting on the target T is suppressed, and deterioration of the manipulation rods (3, 4) is suppressed.

Note that, as illustrated in FIG. 7(a) and FIG. 7(b) as an example, it is preferable that, in a state where the second manipulation rod 4 is in contact with the first abutment face 67a or the second abutment face 67b, at least one of the relative sliding motion of the coupling tool 6A (more specifically, the second receiving part 66) with respect to the second manipulation rod 4 and the relative sliding motion of the coupling tool 6A (more specifically, the first receiving part 61) with respect to the first manipulation rod 3 be allowed. In such a case, even after the second manipulation rod 4 has come into contact with the first abutment face 67a or the second abutment face 67b, relative motion of the second manipulation rod 4 with respect to the first manipulation rod 3 is enabled, which makes it possible to continue the manipulation of the manipulation member 5. For example, the configuration may be such that, after the second manipulation rod 4 has come into contact with the first abutment face 67a or the second abutment face 67b, the second manipulation rod 4 slidingly moves with respect to the second receiving part 66 (see the arrow F3), and afterwards, the first receiving part 61 slidingly moves with respect to the first manipulation rod 3 (see the arrow F4).

As illustrated in FIG. 4(a) as an example, the first receiving part 61 has a shape suitable for holding the first manipulation rod 3. More specifically, it is preferable that the first inner face 62 of the first receiving part 61 have a shape fitted to the first manipulation rod 3 (note that it is preferable that this “fit” be such fit that allows the first receiving part 61 to slidingly move with respect to the first manipulation rod 3 along the longitudinal direction of the first manipulation rod 3). On the other hand, the second receiving part 66 has a shape that allows the second manipulation rod 4 to move in the lateral direction DT inside the second receiving part 66.

Since the function required for the first receiving part 61 and the function required for the second receiving part 66 differ from each other, it is preferable that the first region ARI defined by the first receiving part 61 (more specifically, the first region AR1 inside the first inner face 62) and the second region AR2 defined by the second receiving part 66 (more specifically, the second region AR2 inside the second inner face 67) differ in the shape or size from each other. Alternatively, (1) the shape and size of the first region ARI may be identical to the shape and size of the second region AR2, (2) the external shape of the first manipulation rod 3 may be shaped to exactly fit to the first region AR1, and (3) the external shape of the second manipulation rod 4 may be shaped to be movable in the lateral direction DT in the second region AR2. Also in such a case, both of the function required for the first receiving part 61 and the function required for the second receiving part 66 can be ensured.

To ensure the function required for the first receiving part 61 (the function of holding the first manipulation rod 3), as illustrated in FIG. 4(a) as an example, it is preferable that the shape of the first inner face 62 of the first receiving part 61 be shaped to exactly fit to the external shape of the first manipulation rod 3. For example, when the external shape of the first manipulation rod 3 has a perfect circular shape, it is preferable for the first inner face 62 to have a complementary shape to the perfect circular shape (more specifically, a circular arc shape that exactly fits to a perfect circular shape). Further, it is preferable that, in a state where the first receiving part 61 is attached to the first manipulation rod 3, a spacing that would induce clattering of the first manipulation rod 3 be not present between the first receiving part 61 and the first manipulation rod 3.

To ensure the function required for the second receiving part 66 (the function of allowing lateral direction motion of the second manipulation rod 4), as illustrated in FIG. 4(b) as an example, the second region AR2 may have an elongated shape longer in the lateral direction DT when viewed in the direction along the longitudinal direction of the second manipulation rod 4 (more specifically, may have an elongated shape having a longer axis running in the lateral direction DT). This elongated shape may be an elliptical shape. In the example illustrated in FIG. 4(b), the shape of the second region AR2 is more flattened than the shape of the first region AR1 when viewed in the direction along the longitudinal direction of the second manipulation rod 4.

In the example illustrated in FIG. 8, the opening width W1 of the first side opening OP1 of the first receiving part 61 (hereafter, referred to as “first opening width W1”) differs from the opening width W2 of the second side opening OP2 of the second receiving part 66 (hereafter, referred to as “second opening width W2”). It is preferable that the first opening width W1 be smaller than the outer diameter DI of the first manipulation rod 3. In such a case, the first manipulation rod 3 received in the first receiving part 61 is prevented or suppressed from unintendedly passing through the first side opening OP1 and falling out of the first receiving part 61. It is preferable that the second opening width W2 be smaller than the outer diameter D2 of the second manipulation rod 4. In such a case, the second manipulation rod 4 received in the second receiving part 66 is prevented or suppressed from unintendedly passing through the second side opening OP2 and falling out of the second receiving part 66. Note that, to prevent the first manipulation rod 3 from falling off of the first receiving part 61, the coupling tool 6A may have a closure member that can open and close the first side opening OP1. Further, to prevent the second manipulation rod 4 from falling off of the second receiving part 66, the coupling tool 6A may have a closure member that can open and close the second side opening OP2.

During use of the remote manipulation apparatus 1, the second manipulation rod 4 movable in the lateral direction DT in the second region AR2 may pass through the second side opening OP2 and fall off of the second receiving part 66 due to momentum of motion. On the other hand, since the first manipulation rod 3 is substantially unmovable in the lateral direction DT in the first region AR1, the likelihood of the first manipulation rod 3 passing through the first side opening OP1 and falling off of the first receiving part 61 is relatively low. Accordingly, unlike the example illustrated in FIG. 8, a value V2 obtained by subtracting the second opening width W2 from the outer diameter D2 of the second manipulation rod 4 may be set to a value larger than a value V1 obtained by subtracting the first opening width W1 from the outer diameter D1 of the first manipulation rod 3. A larger value V2 reduces the likelihood of the second manipulation rod 4 passing through the second side opening OP2 and falling off of the second receiving part 66 during use of the remote manipulation apparatus 1.

### (Second Connection Tool 8A)

As illustrated in FIG. 9 as an example, the remote manipulation apparatus 1 may include the second coupling tool 8A in addition to the coupling tool 6A. Further, the remote manipulation apparatus 1 may have a third coupling tool in addition to the coupling tool 6A and the second coupling tool 8A.

In the example illustrated in FIG. 9, the second coupling tool 8A couples the first manipulation rod 3 and the second manipulation rod 4 in a region between the tool 2 and the coupling tool 6A. The second coupling tool 8A includes a third receiving part 81, a fourth receiving part 86, and a second coupling part 95.

In the example illustrated in FIG. 10(a), the third receiving part 81 has a third inner face 82 that holds the first manipulation rod 3. Further, the third receiving part 81 defines a third region AR3 that receives a part of the first manipulation rod 3.

In the example illustrated in FIG. 10(a), the fourth receiving part 86 has a fourth inner face 87 that can come into contact with the second manipulation rod 4. Further, the fourth receiving part 86 defines a fourth region AR4 that receives a part of the second manipulation rod 4. This fourth region AR4 allows the second manipulation rod 4 to move in the lateral direction DT relative to the fourth inner face 87 (see FIG. 10(b)).

The second coupling part 95 couples the third receiving part 81 and the fourth receiving part 86 to each other. In the example illustrated in FIG. 9, the length of the second coupling part 95 (in other words, the gap between the third receiving part 81 and the fourth receiving part 86) is shorter than the length of the first coupling part 75 (in other words, the gap between the first receiving part 61 and the second receiving part 66).

The second coupling tool 8A may have substantially the same structure and/or shape as the coupling tool 6A except that the length of the second coupling part 95 differs from the length of the first coupling part 75. Further, in the present specification, every description for the coupling tool 6A described above is regarded as the description for the second coupling tool 8A by replacing “first receiving part 61”, “first inner face 62”, “second receiving part 66”, “second inner face 67”, “first abutment face 67a”, “second abutment face 67b”, “first coupling part 75”, “first region AR1”, “second region AR2”, “first side opening OP1”, and “second side opening OP2” with “third receiving part 81”, “third inner face 82”, “fourth receiving part 86”, “fourth inner face 87”, “third abutment face 87a”, “fourth abutment face 87b”, “second coupling part 95”, “third region AR3”, “fourth region AR4”, “third side opening OP3”, and “fourth side opening OP4”, respectively, and duplicated description for the second coupling tool 8A will be omitted.

When the remote manipulation apparatus 1 of the embodiment has the second coupling tool 8A in addition to the coupling tool 6A, bending of the first manipulation rod 3 and the second manipulation rod 4 can be more effectively suppressed. Further, because the length of the first coupling part 75 of the coupling tool 6A and the length of the second coupling part 95 of the second coupling tool 8A differ from each other, it is possible to flexibly accommodate the difference between the gap G1 between the first manipulation rod 3 and the second manipulation rod 4 in the region in which the coupling tool 6A is arranged (see FIG. 9) and the gap G2 between the first manipulation rod 3 and the second manipulation rod 4 in the region in which the second coupling tool 8A is arranged (see FIG. 9). Furthermore, motion in the lateral direction DT of the second manipulation rod 4 is allowed in both the second region AR2 defined by the second receiving part 66 of the coupling tool 6A and the fourth region AR4 defined by the fourth receiving part 86 of the second coupling tool 8A, and this enables smooth relative motion of the second manipulation rod 4 with respect to the first manipulation rod 3.

### (Tool 2)

In the examples illustrated in FIG. 2(a) and FIG. 5(a), the tool 2 has the first acting member 21 and the second acting member 22, and the second acting member 22 is coupled to the first acting member 21 so as to be rotatable relative to the first acting member 21 about the first axis AX1.

In the examples illustrated in FIG. 2(a) and FIG. 5(a), the first acting member 21 includes a first portion P1 having the first acting part 212 and a second portion P2 having the proximal end 214 attached to the first manipulation rod 3. The first portion P1 and the second portion P2 may be formed of a single component or may be formed of an assembly of a plurality of components.

In the examples illustrated in FIG. 2(a) and FIG. 5(a), the second acting member 22 includes a third portion P3 having the second acting part 222 and a fourth portion P4 having the proximal end 224 attached to the second manipulation rod 4. In the examples illustrated in FIG. 2(a) and FIG. 5(a), the third portion P3 is coupled to the fourth portion P4 so as to be rotatable about the second axis AX2. Alternatively, the third portion P3 and the fourth portion P4 may be coupled so as to be not rotatable relative to each other, or the third portion P3 and the fourth portion P4 may be formed of a single component.

### (Manipulation Rods 3, 4)

The length of each of the first manipulation rod 3 and the second manipulation rod 4 is set to a length required for gripping or cutting the target T located distant from the manipulation member 5. The length of the first manipulation rod 3 is, for example, 1 m or longer, 1.5 m or longer, or 2 m or longer. Further, the length of the second manipulation rod 4 is, for example, 1 m or longer, 1.5 m or longer, or 2 m or longer. The number of coupling tools (6A, 8A), which couple the first manipulation rod 3 and the second manipulation rod 4 to each other, may be changed in accordance with the lengths of the manipulation rods (3, 4). For example, when the manipulation rods (3, 4) have long lengths, the number of coupling tools (6A, 8A), which couple the first manipulation rod 3 and the second manipulation rod 4 to each other, may be increased.

In the examples illustrated in FIG. 2(a) and FIG. 5(a), the first manipulation rod 3 is thicker than the second manipulation rod 4. Out of the first manipulation rod 3 and the second manipulation rod 4, the thicker manipulation rod is defined as the primary manipulation rod, and the thinner manipulation rod is defined as the secondary manipulation rod. In the examples illustrated in FIG. 2(a) and FIG. 5(a), the first manipulation rod 3 is the primary manipulation rod, and the second manipulation rod 4 is the secondary manipulation rod. Alternatively, the first manipulation rod 3 may be the secondary manipulation rod, and the second manipulation rod 4 may be the primary manipulation rod. Further alternatively, the thickness of the first manipulation rod 3 and the thickness of the second manipulation rod 4 may be the same.

In the examples illustrated in FIG. 2(a) and FIG. 5(a), the first manipulation rod 3 is bent due to manipulation of the manipulation member 5. Alternatively, the second manipulation rod 4 may be bent due to manipulation of the manipulation member 5. Both of the first manipulation rod 3 and the second manipulation rod 4 may be bent due to manipulation of the manipulation member 5.

For example, the first manipulation rod 3 is made of FRP (in other words, made of fiber reinforced plastic). Further, when the target T is an electrical wire such as an overhead electrical line, it is preferable that the first manipulation rod 3 be an electrically insulating manipulation rod. For example, the second manipulation rod 4 is made of FRP (in other words, made of fiber reinforced plastic). Further, when the target T is an electrical wire such as an overhead electrical line, it is preferable that the second manipulation rod 4 be an electrically insulating manipulation rod. Note that the material of each of the first manipulation rod 3 and the second manipulation rod 4 or the properties such as electrical insulation of each of the first manipulation rod 3 and the second manipulation rod 4 is set as appropriate in accordance with the type of the tool 2 or the type or the like of the target T handled by the tool 2. In other words, the material, the property, or the like of each of the first manipulation rod 3 and the second manipulation rod 4 may be any material, any property, or the like without being limited to the example described above.

### (Safe Region Defining Collar 11, Rain Cover Collar 12)

As illustrated in FIG. 2(a) and FIG. 5(a) as examples, a safe region defining collar 11 that defines a safe region may be attached to at least one of the first manipulation rod 3 and the second manipulation rod 4. When the safe region defining collar 11 is attached to the first manipulation rod 3 (or the second manipulation rod 4), the region on the proximal end 3b side (or the proximal end 4b side) from the safe region defining collar 11 is a region that the user can touch during operations, and the region on the distal end 3a side (or the distal end 4a side) from the safe region defining collar 11 is a region that the user should not touch during operations. The safe region defining collar 11 is formed of an electrically insulating material (for example, an electrically insulating resin).

As illustrated in FIG. 2(a) and FIG. 5(a) as examples, a rain cover collar 12 that prevents rainwater from flowing along the first manipulation rod 3 (or the second manipulation rod 4) and dropping on the proximal end 3b side (or the proximal end 4b side) may be attached to at least one of the first manipulation rod 3 and the second manipulation rod 4.

### (Manipulation Member 5)

In the example illustrated in FIG. 11(a), the manipulation member 5 includes a manipulation handle 50, a first connection member 51 connected to the first manipulation rod 3, and a second connection member 55 (more specifically, an arm 55a) connected to the second manipulation rod 4. In the example illustrated in FIG. 11(a), the second connection member 55 (more specifically, the arm 55a) is coupled to the first connection member 51 so as to be rotatable about the third axis AX3. Further, the second connection member 55 (more specifically, the arm 55a) is coupled to the second manipulation rod 4 so as to be rotatable about the fourth axis AX4. In the example illustrated in FIG. 11(a) and FIG. 11(b), the second connection member 55 (more specifically, the arm 55a) is rotatable about the third axis AX3 integrally with the manipulation handle 50.

The manipulation member 5 may have a one-way manipulation mechanism (for example, a ratchet mechanism) that allows the manipulation handle 50 to be manipulated in the first manipulation direction MR1 and inhibits the manipulation handle 50 from being manipulated in the second manipulation direction MR2. Further, the manipulation member 5 may have a release manipulation part 53 that releases activation of the one-way manipulation mechanism so as to allow the manipulation handle 50 to be manipulated in the second manipulation direction MR2. Alternatively or additionally, the manipulation member 5 may have a lock member 56 that fixes the position of the manipulation handle 50 for inhibiting the manipulation handle 50 from being manipulated in both the first manipulation direction MR1 and the second manipulation direction MR2 and a lock member manipulation part 57 that moves the lock member 56 between an advanced position, which is a locked position, and a receded position, which is an unlocked position.

### Third Embodiment

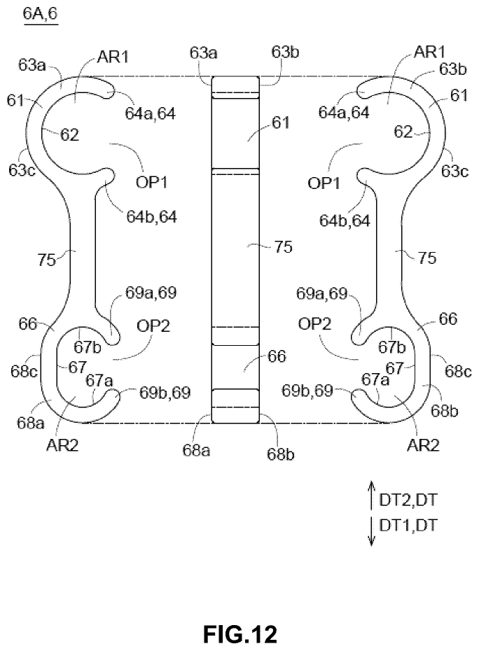

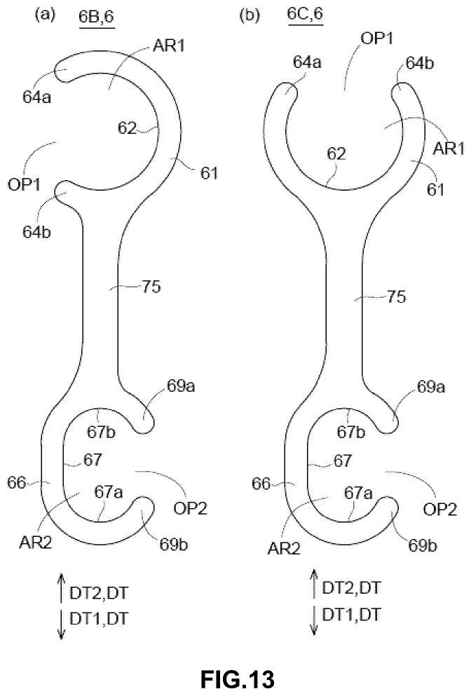

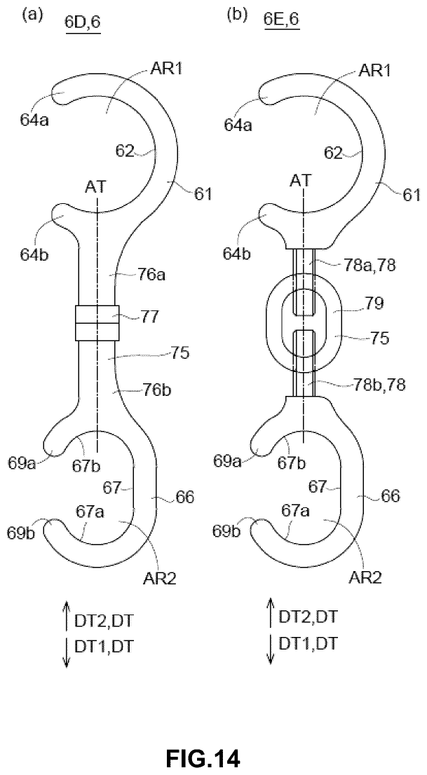

The coupling tool 6 of a third embodiment will be described with reference to FIG. 1 to FIG. 14. FIG. 12 is a general three-side view schematically illustrating the coupling tool 6A of the third embodiment. FIG. 13 represents diagrams schematically illustrating a coupling tool 6B of a first modified example of the third embodiment and a coupling tool 6C of a second modified example of the third embodiment. In this specification, illustration (a) in FIG. 13 may be referred to as FIG. 13(a), and illustration (b) in FIG. 13 may be referred to as FIG. 13(b). FIG. 14 represents diagrams schematically illustrating a coupling tool 6D of a third modified example of the third embodiment and a coupling tool 6E of a fourth modified example of the third embodiment. In this specification, illustration (a) in FIG. 14 may be referred to as FIG. 14(a), and illustration (b) in FIG. 14 may be referred to as FIG. 14(b).

In the third embodiment, features different from the first embodiment and the second embodiment will be mainly described, and duplicated description for features that have already been described in the first embodiment or the second embodiment will be omitted. It is therefore obvious that, even when not explicitly described in the third embodiment, the features that have already been described in the first embodiment or the second embodiment can be employed in the third embodiment. In particular, the features described for “coupling tool 6A” in the first embodiment or the second embodiment can be employed in the coupling tool 6 of the third embodiment. Further, the coupling tool 6 described below can be employed as a coupling tool that couples the first manipulation rod 3 and the second manipulation rod 4 to each other in the first embodiment or the second embodiment described above.

The coupling tool 6 of the third embodiment is a coupling tool for coupling the first manipulation rod 3 of the remote manipulation apparatus 1 (for example, see FIG. 1) and the second manipulation rod 4 of the remote manipulation apparatus 1 to each other to suppress bending of the first manipulation rod 3 and the second manipulation rod 4.

As illustrated in FIG. 4(a) to FIG. 4(c) as an example, the coupling tool 6 includes (1) the first receiving part 61 having the first inner face 62 that can hold the first manipulation rod 3 and defining the first region AR1 that receives a part of the first manipulation rod 3, (2) the second receiving part 66 having the second inner face 67 that can come into contact with the second manipulation rod 4, defining the second region AR2 that receives a part of the second manipulation rod 4, and configured to allow the second manipulation rod 4 to move in the lateral direction DT relative to the second inner face 67 in the second region AR2, and (3) the first coupling part 75 that couples the first receiving part 61 and the second receiving part 66 to each other.

Thus, the remote manipulation apparatus to which the coupling tool 6 of the third embodiment is attached achieves the same advantageous effects as the remote manipulation apparatus 1 of the first embodiment or the second embodiment.

Optional, additional configurations that can be employed in the coupling tool 6 of the third embodiment will be described with reference to FIG. 1 to FIG. 14.

### (First Receiving Part 61 and Second Receiving Part 66)

In the example illustrated in FIG. 12, the first receiving part 61 has a first end face 63a and a second end face 63b. The direction from the first end face 63a to the second end face 63b matches the extending direction of the first manipulation rod 3 received in the first receiving part 61. In the following, view in the direction from the first end face 63a to the second end face 63b is referred to as “end face view”.

In the example illustrated in FIG. 12, the first receiving part 61 has a substantially C-shape as a whole in the end face view. The first receiving part 61 may have a substantially C-shaped first inner face 62 in the end face view or may have a substantially C-shaped first outer face 63c in the end face view.

In the example illustrated in FIG. 12, the first receiving part 61 has two lip parts 64 (more specifically, a first lip part 64a and a second lip part 64b) defining the first side opening OP1. The first lip part 64a and the second lip part 64b are elastically deformable in directions away from each other. This elastic deformation enables the first manipulation rod 3 to pass through the first side opening OP1 and enter the inside of the first receiving part 61. Further, restoration of the first lip part 64a and the second lip part 64b to their original shapes prevents unintended detachment of the first manipulation rod 3 from the first receiving part 61.

The second receiving part 66 has a first end face 68a and a second end face 68b. The direction from the first end face 68a to the second end face 68b substantially matches the extending direction of the second manipulation rod 4 received in the second receiving part 66.

In the example illustrated in FIG. 12, the second receiving part 66 has a substantially C-shape extending in the direction from the first receiving part 61 to the second receiving part 66 as a whole in the end face view. The second receiving part 66 may have a substantially C-shaped second inner face 67 extending in the direction from the first receiving part 61 to the second receiving part 66 as a whole in the end face view or may have a substantially C-shaped second outer face 68c extending in the direction from the first receiving part 61 to the second receiving part 66 in the end face view.

In the example illustrated in FIG. 12, the second receiving part 66 has two lip parts 69 (more specifically, a third lip part 69a and a fourth lip part 69b) defining the second side opening OP2. The third lip part 69a and the fourth lip part 69b are elastically deformable in directions away from each other. This elastic deformation enables the second manipulation rod 4 to pass through the second side opening OP2 and enter the inside of the second receiving part 66. Further, restoration of the third lip part 69a and the fourth lip part 69b to the original shapes prevents unintended detachment of the second manipulation rod 4 from the second receiving part 66.

In the example illustrated in FIG. 12, the first side opening OP1 and the second side opening OP2 are opened in the same direction in the end face view. More specifically, the first side opening OP1 and the second side opening OP2 are arranged on the same side with respect to a line connecting the center of the first receiving part 61 to the center of the second receiving part 66 in the end face view. Alternatively, as illustrated in FIG. 13(a) as an example, the first side opening OP1 and the second side opening OP2 may be opened in opposite direction to each other in the end face view. More specifically, the second side opening OP2 may be arranged on the opposite side to the side on which the first side opening OP1 is arranged with respect to a line connecting the center of the first receiving part 61 to the center of the second receiving part 66 in the end face view.

Further, as illustrated in FIG. 13(b) as an example, the first side opening OP1 may be arranged in the farthest portion from the first coupling part 75 of the first receiving part 61. Alternatively or additionally, the second side opening OP2 may be arranged in the farthest portion from the first coupling part 75 of the second receiving part 66.

### (First Coupling Part 75)

In the example illustrated in FIG. 12, the first coupling part 75 couples the first receiving part 61 and the second receiving part 66 to each other so that relative rotation between the first receiving part 61 and the second receiving part 66 is inhibited. Further, in the example illustrated in FIG. 12, the first coupling part 75 couples the first receiving part 61 and the second receiving part 66 to each other so that the distance between the first receiving part 61 and the second receiving part 66 is unable to be changed. In such a case, the structure of the first coupling part 75 can be simple.

Modified examples of the first coupling part 75 will be described. FIG. 14(a) illustrates the coupling tool 6D of a third modified example. In the example illustrated in FIG. 14(a), the first coupling part 75 couples the first receiving part 61 and the second receiving part 66 to each other so that relative rotation between the first receiving part 61 and the second receiving part 66 is allowed. When this relative rotation is allowed, the coupling tool 6D can be flexibly adapted for irregular deformation (for example, torsional deformation) of the first manipulation rod 3 and the second manipulation rod 4.

In the example illustrated in FIG. 14(a), the first coupling part 75 has a first portion 76a coupled to the first receiving part 61, a second portion 76b coupled to the second receiving part 66, and a rotation joint 77. The rotation joint 77 connects the first portion 76a and the second portion 76b to each other so that the second portion 76b is rotatable relative to the first portion 76a about the rotation axis AT extending in the direction from the first receiving part 61 to the second receiving part 66. Note that it is obvious that the specific configuration of the first coupling part 75 that couples the first receiving part 61 and the second receiving part 66 in a relatively rotatable manner is not limited to the example illustrated in FIG. 14(a).

FIG. 14(b) illustrates the coupling tool 6E in a fourth modified example. In the example illustrated in FIG. 14(b), the first coupling part 75 couples the first receiving part 61 and the second receiving part 66 to each other so that the distance between the first receiving part 61 and the second receiving part 66 can be changed. In such a case, as illustrated in FIG. 1 as an example, when the gap between the first manipulation rod 3 and the second manipulation rod 4 is changed along the longitudinal direction of the first manipulation rod 3, the coupling tool 6E can be attached flexibly to desired positions of the first manipulation rod 3 and the second manipulation rod 4.

In the example illustrated in FIG. 14(b), the first coupling part 75 has a threaded rod 78 used for adjusting the distance between the first receiving part 61 and the second receiving part 66. It is preferable that the threaded rod 78 extend along the axis AT parallel to the direction from the first receiving part 61 to the second receiving part 66. The first coupling part 75 may have a first threaded rod 78a coupled to the first receiving part 61, a second threaded rod 78b coupled to the second receiving part 66, and a threaded rod manipulation part 79 that moves the first threaded rod 78a and the second threaded rod 78b. In the example illustrated in FIG. 14(b), one of the first threaded rod 78a and the second threaded rod 78b is a forward threaded rod, and the other is a reverse threaded rod. Further, the threaded rod manipulation part 79 is screwed onto the first threaded rod 78a and the second threaded rod 78b, respectively.

In the example illustrated in FIG. 14(b), when the threaded rod manipulation part 79 is manipulated, the threaded rod 78 (more specifically, the first threaded rod 78a and the second threaded rod 78b) moves along the axis AT. As a result, the distance between the first receiving part 61 and the second receiving part 66 is adjusted.

In the example illustrated in FIG. 14(b), the first coupling part 75 couples the first receiving part 61 and the second receiving part 66 to each other so that the distance between the first receiving part 61 and the second receiving part 66 can be changed and relative rotation between the first receiving part 61 and the second receiving part 66 (more specifically, relative rotation about the axis AT) is allowed.

Note that it is obvious that the specific configuration of the first coupling part 75 that couples the first receiving part 61 and the second receiving part 66 to each other so that the distance between the first receiving part 61 and the second receiving part 66 can be changed is not limited to the example illustrated in FIG. 14(b). Further, although the first receiving part 61 and the second receiving part 66 are rigidly coupled to each other so that the distance between the first receiving part 61 and the second receiving part 66 can be changed in the example illustrated in FIG. 14(b), alternatively, the first receiving part 61 and the second receiving part 66 may be elastically coupled to each other so that the distance between the first receiving part 61 and the second receiving part 66 can be changed. In other words, the first coupling part 75 coupling the first receiving part 61 and the second receiving part 66 to each other may be an expandable coupling part.

### Fourth Embodiment

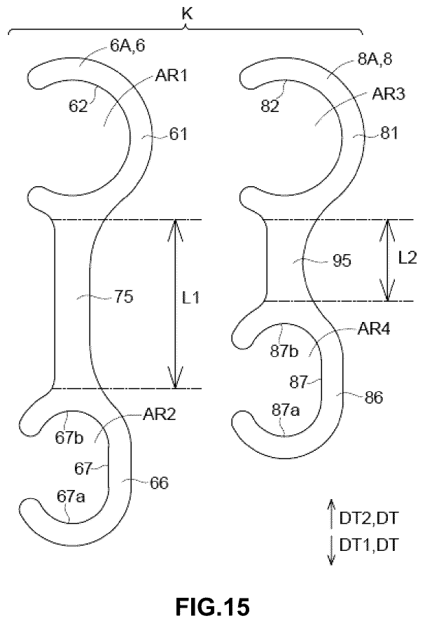

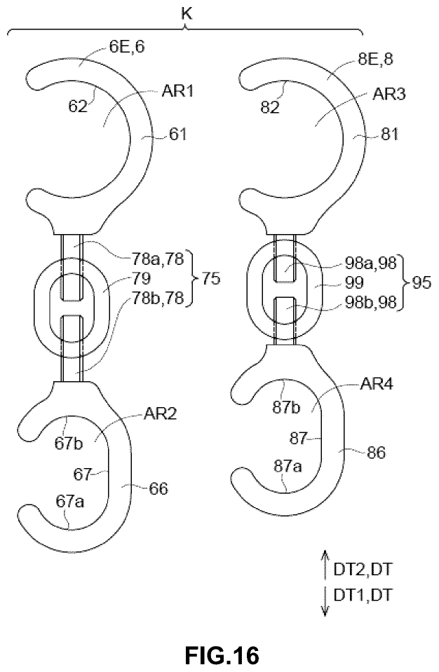

A kit K including the coupling tool 6 and the second coupling tool 8 of a fourth embodiment will be described with reference to FIG. 1 to FIG. 16. FIG. 15 represents diagrams schematically illustrating an example of the kit K including the coupling tool 6 and the second coupling tool 8 of the fourth embodiment. FIG. 16 represents diagrams schematically illustrating another example of the kit K including the coupling tool 6 and the second coupling tool 8 of the fourth embodiment.

In the fourth embodiment, features different from the first embodiment to the third embodiment will be mainly described, and duplicated description for features that have already been described in the first embodiment, the second embodiment, or the third embodiment will be omitted. It is therefore obvious that, even when not explicitly described in the fourth embodiment, the features that have already been described in the first embodiment, the second embodiment, or the third embodiment can be employed in the fourth embodiment. In particular, the features described for “coupling tool (6A, 6B, 6C, 6D, 6E)” and “second coupling tool 8A” in the first embodiment, the second embodiment, or the third embodiment can be employed in “coupling tool 6” and “second coupling tool 8” of the fourth embodiment. Further, the coupling tool 6 and the second coupling tool 8 described below can be employed as a coupling tool and a second coupling tool that couple the first manipulation rod 3 and the second manipulation rod 4 to each other in the first embodiment or the second embodiment described above.

The kit K of the fourth embodiment includes the coupling tool 6 and the second coupling tool 8. The kit K may include the third coupling tool in addition to the coupling tool 6 and the second coupling tool 8. As the coupling tool 6, the coupling tool 6A described in the first embodiment or the second embodiment may be employed, or the coupling tool (6A, 6B, 6C, 6D, 6E) described in the third embodiment may be employed. Since the coupling tool 6 has already been described in the first embodiment to the third embodiment, duplicated description for the coupling tool 6 will be omitted.

The second coupling tool 8 is a coupling tool for suppressing bending of the first manipulation rod 3 and the second manipulation rod 4 by coupling the first manipulation rod 3 of the remote manipulation apparatus 1 (for example, see FIG. 1) and the second manipulation rod 4 of the remote manipulation apparatus 1 to each other. As the second coupling tool 8, the second coupling tool 8A described in the first embodiment or the second embodiment may be employed, or other second coupling tools may be employed.

As illustrated in FIG. 10(a) as an example, the second coupling tool 8 includes (1) the third receiving part 81 having the third inner face 82 that can hold the first manipulation rod 3 and defining the third region AR3 that receives a part of the first manipulation rod 3, (2) the fourth receiving part 86 having the fourth inner face 87 that can come into contact with the second manipulation rod 4, defining the fourth region AR4 that receives a part of the second manipulation rod 4, and configured to allow the second manipulation rod 4 to move in the lateral direction DT relative to the fourth inner face 87 in the fourth region AR4, and (3) the second coupling part 95 that couples the third receiving part 81 and the fourth receiving part 86 to each other.

In the example illustrated in FIG. 15, the length L1 of the first coupling part 75 of the coupling tool 6 and the length L2 of the second coupling part 95 of the second coupling tool 8 differ from each other. Because the length L1 and the length L2 differ from each other, it is possible to flexibly accommodate the difference between the gap Gl between the first manipulation rod 3 and the second manipulation rod 4 in the region in which the coupling tool 6 is arranged (see FIG. 9) and the gap G2 between the first manipulation rod 3 and the second manipulation rod 4 in the region in which the second coupling tool 8 is arranged (see FIG. 9).

Alternatively or additionally, at least one of the length L1 of the first coupling part 75 and the length L2 of the second coupling part 95 may be adjustable.

In the example illustrated in FIG. 16, the length of the first coupling part 75 of the coupling tool 6 is adjustable. As the coupling tool 6, the coupling tool 6E described in the third embodiment may be employed. Alternatively or additionally, the length of the second coupling part 95 of the second coupling tool 8 may be adjustable. As the mechanism for adjusting the length of the second coupling part 95, for example, the same mechanism as the mechanism for adjusting the length of the first coupling part 75 of the coupling tool 6 may be employed. In the example illustrated in FIG. 16, the second coupling part 95 of the second coupling tool 8E includes a threaded rod 98 used for adjusting the distance between the third receiving part 81 and the fourth receiving part 86 (more specifically, the first threaded rod 98a and the second threaded rod 98b) and a threaded rod manipulation part 99 used for moving the threaded rod 98 (more specifically, the first threaded rod 98a and the second threaded rod 98b).

In the example illustrated in FIG. 16, because at least one of the length of the first coupling part 75 and the length L2 of the second coupling part is adjustable, it is possible to flexibly accommodate the difference between the gap G1 between the first manipulation rod 3 and the second manipulation rod 4 in the region in which the coupling tool 6 is arranged (see FIG. 9) and the gap G2 between the first manipulation rod 3 and the second manipulation rod 4 in the region in which the second coupling tool 8 is arranged (see FIG. 9).

### (Method of Using Remote Manipulation Apparatus 1)

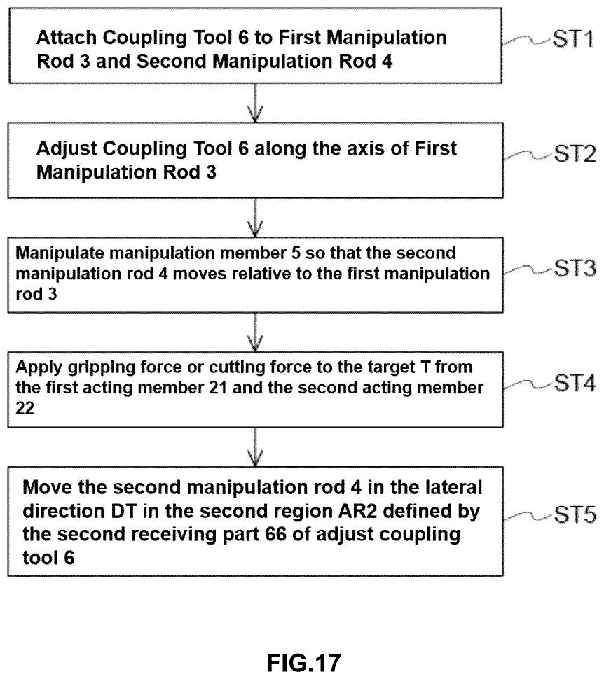

A method of using the remote manipulation apparatus 1 of the embodiment will be described with reference to FIG. 1 to FIG. 17. FIG. 17 is a flowchart illustrating an example of the method of using the remote manipulation apparatus 1 of the embodiment.

The remote manipulation apparatus used in the method of using the remote manipulation apparatus 1 of the embodiment may be the remote manipulation apparatus 1A of the first embodiment, may be the remote manipulation apparatus 1B of the second embodiment, or may be other remote manipulation apparatuses. Further, the coupling tool 6 of this remote manipulation apparatus 1 may be the coupling tool 6A described in the first embodiment or the second embodiment, may be the coupling tool (6A, 6B, 6C, 6D, 6E) described in the third embodiment, or may be other coupling tools. Furthermore, when this remote manipulation apparatus 1 has the second coupling tool 8, the second coupling tool 8 may be the second coupling tool 8A described in the first embodiment or the second embodiment, may be the second coupling tool 8E described in the fourth embodiment, or may be other second coupling tools.

As illustrated in FIG. 1, FIG. 2, FIG. 5, and the like as examples, the remote manipulation apparatus 1 includes (1) the tool 2 having the first acting member 21 and the second acting member 22 and capable of gripping or cutting the target T by the first acting member 21 and the second acting member 22, (2) the first manipulation rod 3 coupled to the first acting member 21, (3) the second manipulation rod 4 coupled to the second acting member 22, (4) the manipulation member 5 coupled to the first manipulation rod 3 and the second manipulation rod 4, respectively, and configured to move the second manipulation rod 4 relative to the first manipulation rod 3 to remotely manipulate at least one of the first acting member 21 and the second acting member 22, and (5) the coupling tool 6 configured to couple the first manipulation rod 3 and the second manipulation rod 4 to each other in the region between the tool 2 and the manipulation member 5. Further, as illustrated in FIG. 4 and the like as examples, the coupling tool 6 includes (6) the first receiving part 61 having the first inner face 62 that holds the first manipulation rod 3 and defining the first region AR1 that receives a part of the first manipulation rod 3, (7) the second receiving part 66 having the second inner face 67 that can come into contact with the second manipulation rod 4 and defining the second region AR2 that receives a part of the second manipulation rod 4, and (8) the first coupling part 75 that couples the first receiving part 61 and the second receiving part 66 to each other.

In a first step ST1, the coupling tool 6 is attached to the first manipulation rod 3 and the second manipulation rod 4. The first step ST1 is a first attachment step.

When the first receiving part 61 of the coupling tool 6 has the first side opening OP1, the first attachment step includes a first insertion step of inserting the first manipulation rod 3 in the first receiving part 61 via the first side opening OP1 (see FIG. 8). When the first side opening OP1 is defined by the first lip part 64a and the second lip part 64b, the first insertion step may include pushing the first manipulation rod 3 against the first lip part 64a and the second lip part 64b to elastically deform the first lip part 64a and the second lip part 64b in the direction away from each other.

When the second receiving part 66 of the coupling tool 6 has the second side opening OP2, the first attachment step includes a second insertion step of inserting the second manipulation rod 4 in the second receiving part 66 via the second side opening OP2 (see FIG. 8). When the second side opening OP2 is defined by the third lip part 69a and the fourth lip part 69b, the second insertion step may include pushing the second manipulation rod 4 against the third lip part 69a and the fourth lip part 69b to elastically deform the third lip part 69a and the fourth lip part 69b in the direction away from each other.

Note that, when the coupling tool 6 has already been attached to the first manipulation rod 3 and the second manipulation rod 4, the first step ST1 is omitted.

Additionally, the method of using the remote manipulation apparatus 1 may include a step of attaching the second coupling tool 8 to the first manipulation rod 3 and the second manipulation rod 4 (hereafter, referred to as “second attachment step”) (see FIG. 10(a) and FIG. 10(b)). When the third receiving part 81 of the second coupling tool 8 has the third side opening OP3, the second attachment step may include a third insertion step of inserting the first manipulation rod 3 in the third receiving part 81 via the third side opening OP3. Further, when the fourth receiving part 86 of the second coupling tool 8 has the fourth side opening OP4, the second attachment step may include a fourth insertion step of inserting the second manipulation rod 4 in the fourth receiving part 86 via the fourth side opening OP4.

Note that, when the second coupling tool 8 has already been attached to the first manipulation rod 3 and the second manipulation rod 4 or when the remote manipulation apparatus 1 does not have the second coupling tool 8, the second attachment step is omitted.

In a second step ST2, the position of the coupling tool 6 in the direction along the longitudinal direction of the first manipulation rod 3 is adjusted (see the arrow F2 in FIG. 6(a) or the arrow F1 in FIG. 6(b)). The second step ST2 is a position adjustment step. For example, the position adjustment step includes slidingly moving the coupling tool 6 along the longitudinal direction of the first manipulation rod 3 with the coupling tool 6 being attached to the first manipulation rod 3 and the second manipulation rod 4.

As illustrated in FIG. 6(b) as an example, when the coupling tool 6 is slidingly moved toward the distal end 3a of the first manipulation rod 3 along the first manipulation rod 3, the position of the first abutment face 67a on the first lateral direction DT1 side can be a position more distant from the second manipulation rod 4. In contrast, as illustrated in FIG. 6(a) as an example, when the coupling tool 6 is slidingly moved toward the proximal end 3b of the first manipulation rod 3 along the first manipulation rod 3, the position of the first abutment face 67a on the first lateral direction DT1 side can be a position closer to the second manipulation rod 4.

Additionally, when the remote manipulation apparatus 1 has the second coupling tool 8, the position of the second coupling tool 8 in the direction along the longitudinal direction of the first manipulation rod 3 may be adjusted. For example, the adjustment of the position of the second coupling tool 8 includes slidingly moving the second coupling tool 8 along the longitudinal direction of the first manipulation rod 3 with the second coupling tool 8 being attached to the first manipulation rod 3 and the second manipulation rod 4.

Note that, when it is not necessary to perform position adjustment of the coupling tool 6 (or the coupling tool 6 and the second coupling tool 8) with respect to the first manipulation rod 3 and the second manipulation rod 4, the second step ST2 is omitted.

In a third step ST3, the manipulation member 5 is manipulated. The third step ST3 is a manipulation step. In the manipulation step, the manipulation member 5 is manipulated so that the second manipulation rod 4 moves relative to the first manipulation rod 3. For example, this manipulation includes manipulating the manipulation handle 50 in the first manipulation direction MR1 (see FIG. 11).

In a fourth step ST4, gripping force or cutting force is applied to the target T from the first acting member 21 and the second acting member 22. The fourth step ST4 is a force application step. In the force application step, due to the relative motion of the second manipulation rod 4 with respect to the first manipulation rod 3, gripping force or cutting force is applied to the target T from the first acting member 21 and the second acting member 22. Due to the execution of the fourth step ST4, the target T is gripped or cut by the first acting member 21 and the second acting member 22 (see FIG. 2(b) or FIG. 5(b)).

In the example illustrated in FIG. 2(a) and FIG. 2(b) or FIG. 5(a) and FIG. 5(b), the force application step includes reducing the distance between the first acting part 212 of the first acting member 21 and the second acting part 222 of the second acting member 22 by relative motion of the second manipulation rod 4 with respect to the first manipulation rod 3.

In a fifth step ST5, the second manipulation rod 4 is moved in the lateral direction DT in the second region AR2 defined by the second receiving part 66. The fifth step ST5 is a lateral motion step. In the lateral motion step, in response to the relative motion of the second manipulation rod 4 with respect to the first manipulation rod 3, the second manipulation rod 4 is moved in the lateral direction DT relative to the second inner face 67 in the second region AR2 defined by the second receiving part 66 (see FIG. 4(b) and FIG. 4(c)).

The fifth step ST5 is performed in association with the third step ST3 or the fourth step ST4 being performed. More specifically, in the examples illustrated in FIG. 2(b) and FIG. 5(b), the manipulation member 5 is manipulated (the third step ST3), thereby the second manipulation rod 4 moves in the direction away from the first manipulation rod 3, and as a result, the second manipulation rod 4 moves in the lateral direction DT in the second region AR2 defined by the second receiving part 66. Further, in the examples illustrated in FIG. 2(b) or FIG. 5(b), gripping force or cutting force is applied to the target T (the fourth step ST4), thereby bending occurs in at least one of the first manipulation rod 3 and the second manipulation rod 4, and as a result, the second manipulation rod 4 moves in the lateral direction DT in the second region AR2 defined by the second receiving part 66.

As illustrated in FIG. 4(b) and FIG. 4(c) as an example, the lateral motion step (the fifth step ST5) may include switching the contact state between the second manipulation rod 4 and the second inner face 67 from a first state where the second manipulation rod 4 is spaced apart from the first abutment face 67a on the first lateral direction DT1 side of the second inner face 67 (see FIG. 4(b)) to a second state where the second manipulation rod 4 is in contact with this first abutment face 67a (see FIG. 4(c)). Alternatively or additionally, the lateral motion step (the fifth step ST5) may include switching the contact state between the second manipulation rod 4 and the second inner face 67 from a third state where the second manipulation rod 4 is spaced apart from the second abutment face 67b on the second lateral direction DT2 side of the second inner face 67 (see FIG. 4(b)) to a fourth state where the second manipulation rod 4 is in contact with this second abutment face 67b (see FIG. 7(b)).

Further, as illustrated in FIG. 9 as an example, when the remote manipulation apparatus 1 has the second coupling tool 8, the lateral motion step (the fifth step ST5) may include the second manipulation rod 4 being moved in the lateral direction DT relative to the fourth inner face 87 in the fourth region AR4 defined by the fourth receiving part 86 of the second coupling tool 8.

As discussed above, in the method of using the remote manipulation apparatus 1 in the embodiment, the remote manipulation apparatus 1 includes the coupling tool 6 that couples the first manipulation rod 3 and the second manipulation rod 4 to each other, and this coupling tool 6 allows the second manipulation rod 4 to move in the lateral direction DT in the second region AR2. Thus, in the method of using the remote manipulation apparatus 1 in the embodiment, bending of the first manipulation rod 3 and the second manipulation rod 4 is suppressed by the coupling tool 6, and smooth relative motion of the second manipulation rod 4 with respect to the first manipulation rod 3 is allowed by the second region AR2.

Further, it is assumed that the lateral motion step (the fifth step ST5) includes the contact state between the second manipulation rod 4 and the second inner face 67 being switched from the first state where the second manipulation rod 4 is spaced apart from the first abutment face 67a to the second state where the second manipulation rod 4 is in contact with this first abutment face 67a. In such a case, moderate bending of the first manipulation rod 3 and the second manipulation rod 4 in the outward bending direction is allowed in the first state where the second manipulation rod 4 is spaced apart from the first abutment face 67a, and excessive bending of the first manipulation rod 3 and the second manipulation rod 4 in the outward bending direction is prevented in the second state where the second manipulation rod 4 is in contact with the first abutment face 67a.

Further, it is assumed that the lateral motion step (the fifth step ST5) includes the contact state between the second manipulation rod 4 and the second inner face 67 being switched from the third state where the second manipulation rod 4 is spaced apart from the second abutment face 67b to the fourth state where the second manipulation rod 4 is in contact with this second abutment face 67b. In such a case, moderate bending of the first manipulation rod 3 and the second manipulation rod 4 in the inward bending direction is allowed in the third state where the second manipulation rod 4 is spaced apart from the second abutment face 67b, and excessive bending of the first manipulation rod 3 and the second manipulation rod 4 in the inward bending direction is prevented in the fourth state where the second manipulation rod 4 is in contact with the second abutment face 67b.

After the third step ST3 to the fifth step ST5 are performed, the position of the manipulation handle 50 of the manipulation member 5 may be fixed by the lock member 56. When the position of the manipulation handle 50 is fixed, for example, a state where the target T is gripped by the tool 2 can be maintained.

It is apparent that the present invention is not limited to each embodiment or each modified example described above and each embodiment or each modified example may be modified or changed as appropriate within the scope of the technical concept of the present invention. Further, any component used in each embodiment or each modified example can be combined with another embodiment or another modified example, or any component can be omitted in each embodiment or each modified example.

### INDUSTRIAL APPLICABILITY

With the use of the remote manipulation apparatus, the coupling tool, the kit including the coupling tool and the second coupling tool, and the method of using the remote manipulation apparatus of the present invention, bending of the first manipulation rod and the second manipulation rod is suppressed, and smooth relative motion of the second manipulation rod with respect to the first manipulation rod is allowed. Thus, a reduction in gripping force or cutting force acting on a target is suppressed, and deterioration of the first manipulation rod and the second manipulation rod is suppressed. Therefore, the remote manipulation apparatus, the coupling tool, the kit including the coupling tool and the second coupling tool, and the method of using the remote manipulation apparatus of the present invention are useful for business entities that perform operations by using a remote manipulation apparatus and manufacturers that manufacture remote manipulation apparatuses or coupling tools.

### LIST OF REFERENCE SYMBOLS

1, 1A. 1B remote manipulation apparatus, 2 tool, 2A gripping tool, 2B cutting tool, 3 first manipulation rod, 3a distal end, 3b proximal end, 4 second manipulation rod, 4a distal end, 4b proximal end, 5 manipulation member, 6, 6A, 6B, 6C, 6D, 6E coupling tool, 8, 8E second coupling tool, 11 safe region defining collar, 12 rain cover collar, 21 first acting member, 21a first gripping member, 21b first cutting member, 22 second acting member, 22a second gripping member, 22b second cutting member, 50 manipulation handle, 51 first connection member, 52 second connection member, 53 release manipulation part, 55 second connection member, 55a arm, 56 lock member, 57 lock member manipulation part, 61 first receiving part, 62 first inner face, 63a first end face, 63b second end face, 63c first outer face, 64 lip part, 64a first lip part, 64b second lip part, 66 second receiving part, 67 second inner face, 67a first abutment face, 67b second abutment face, 68a first end face, 68b second end face, 68c second outer face, 69 lip part, 69a third lip part, 69b fourth lip part, 75 first coupling part, 76a first portion, 76b second portion, 77 rotation joint, 78 threaded rod, 78a first threaded rod, 78b second threaded rod, 79 threaded rod manipulation part, 81 third receiving part, 82 third inner face, 86 fourth receiving part, 87 fourth inner face, 87a third abutment face, 87b fourth abutment face, 95 second coupling part, 98 threaded rod, 98a first threaded rod, 98b second threaded rod, 99 threaded rod manipulation part, 212 first acting part, 212a first gripping part, 212b first cutting blade, 214 proximal end, 222 second acting part, 222a second gripping part, 222b second cutting blade, 224 proximal end, AR1 first region, AR2 second region, AR3 third region, AR4 fourth region, K kit, OP1 first side opening, OP2 second side opening, OP3 third side opening, OP4 fourth side opening, P1 first portion, P2 second portion, P3 third portion, P4 fourth portion, T target

1. A remote manipulation apparatus comprising:
a tool having a first acting member and a second acting member and configured to grip or cut a target by the first acting member and the second acting member;
a first manipulation rod coupled to the first acting member;
a second manipulation rod coupled to the second acting member;
a manipulation member coupled to the first manipulation rod and the second manipulation rod, respectively, and configured to remotely manipulate at least one of the first acting member and the second acting member by relative motion of the second manipulation rod with respect to the first manipulation rod; and
a coupling tool configured to couple the first manipulation rod and the second manipulation rod to each other in a region between the tool and the manipulation member,
wherein the coupling tool comprises
a first receiving part having a first inner face that holds the first manipulation rod and defining a first region that receives a part of the first manipulation rod,
a second receiving part having a second inner face that is able to come into contact with the second manipulation rod, defining a second region that receives a part of the second manipulation rod, and configured to allow the second manipulation rod to move in a lateral direction relative to the second inner face in the second region, and
a first coupling part configured to couple the first receiving part and the second receiving part to each other.

2. The remote manipulation apparatus according to claim 1, wherein in a state where the coupling tool is attached to the first manipulation rod and the second manipulation rod, the coupling tool is slidingly movable with respect to the first manipulation rod along the longitudinal direction of the first manipulation rod.

3. The remote manipulation apparatus according to claim 1,
wherein when a direction from the first receiving part to the second receiving part is defined as a first lateral direction, and a direction from the second receiving part to the first receiving part is defined as a second lateral direction, the second inner face of the second receiving part comprises
a first abutment face arranged on the first lateral direction side of the second region and configured to prevent an increase in a gap between the first manipulation rod and the second manipulation rod, and
a second abutment face arranged on the second lateral direction side of the second region and configured to prevent a reduction in the gap between the first manipulation rod and the second manipulation rod, and
wherein the second region between the first abutment face and the second abutment face allows the increase in the gap between the first manipulation rod and the second manipulation rod and the reduction in the gap between the first manipulation rod and the second manipulation rod.

4. The remote manipulation apparatus according to claim 2,
wherein when a direction from the first receiving part to the second receiving part is defined as a first lateral direction, and a direction from the second receiving part to the first receiving part is defined as a second lateral direction, the second inner face of the second receiving part comprises
a first abutment face arranged on the first lateral direction side of the second region and configured to prevent an increase in a gap between the first manipulation rod and the second manipulation rod, and
a second abutment face arranged on the second lateral direction side of the second region and configured to prevent a reduction in the gap between the first manipulation rod and the second manipulation rod, and
wherein the second region between the first abutment face and the second abutment face allows the increase in the gap between the first manipulation rod and the second manipulation rod and the reduction in the gap between the first manipulation rod and the

5. The remote manipulation apparatus according to claim 1, wherein the first region and the second region differ in shape or size from each other.

6. The remote manipulation apparatus according to claim 5, wherein the second region has an elongated shape longer in the lateral direction when viewed in a direction along the longitudinal direction of the second manipulation rod.

7. The remote manipulation apparatus according to claim 1 further comprising a second coupling tool configured to couple the first manipulation rod and the second manipulation rod to each other in a region between the tool and the coupling tool,
wherein the second coupling tool comprises
a third receiving part having a third inner face that holds the first manipulation rod and defining a third region that receives a part of the first manipulation rod,
a fourth receiving part having a fourth inner face that is able to come into contact with the second manipulation rod, defining a fourth region that receives a part of the second manipulation rod, and configured to allow the second manipulation rod to move in the lateral direction relative to the fourth inner face in the fourth region, and
a second coupling part that couples the third receiving part and the fourth receiving part to each other, and
wherein the length of the second coupling part is shorter than the length of the first coupling part.

8. A coupling tool configured to couple a first manipulation rod of a remote manipulation apparatus and a second manipulation rod of the remote manipulation apparatus to each other to suppress bending of the first manipulation rod and the second manipulation rod, the coupling tool comprising:
a first receiving part having a first inner face that is able to hold the first manipulation rod and defining a first region that receives a part of the first manipulation rod;
a second receiving part having a second inner face that is able to come into contact with the second manipulation rod, defining a second region that receives a part of the second manipulation rod, and configured to allow the second manipulation rod to move in a lateral direction relative to the second inner face in the second region; and
a first coupling part that couples the first receiving part and the second receiving part to each other.

9. The coupling tool according to claim 8, wherein the first coupling part couples the first receiving part and the second receiving part to each other so that the distance between the first receiving part and the second receiving part is changeable, couples the first receiving part and the second receiving part to each other so that relative rotation between the first receiving part and the second receiving part is allowed, or couples the first receiving part and the second receiving part to each other so that the distance between the first receiving part and the second receiving part is changeable and relative rotation between the first receiving part and the second receiving part is allowed.

10. A kit comprising:
the coupling tool according to claim 8; and
a second coupling tool,
wherein the second coupling tool comprises
a third receiving part having a third inner face that is able to hold the first manipulation rod and defining a third region that receives a part of the first manipulation rod,
a fourth receiving part having a fourth inner face that is able to come into contact with the second manipulation rod, defining a fourth region that receives a part of the second manipulation rod, and configured to allow the second manipulation rod to move in the lateral direction relative to the fourth inner face in the fourth region, and
a second coupling part that couples the third receiving part and the fourth receiving part to each other, and
wherein the length of the first coupling part and the length of the second coupling part differ from each other, or at least one of the length of the first coupling part and the length of the second coupling part is adjustable.

11. A method of using a remote manipulation apparatus,
wherein the remote manipulation apparatus comprises
a tool having a first acting member and a second acting member and configured to grip or cut a target by the first acting member and the second acting member,
a first manipulation rod coupled to the first acting member,
a second manipulation rod coupled to the second acting member,
a manipulation member coupled to the first manipulation rod and the second manipulation rod, respectively, and configured to remotely manipulate at least one of the first acting member and the second acting member by relative motion of the second manipulation rod with respect to the first manipulation rod, and
a coupling tool configured to couple the first manipulation rod and the second manipulation rod to each other in a region between the tool and the manipulation member,
wherein the coupling tool comprises
a first receiving part having a first inner face that holds the first manipulation rod and defining a first region that receives a part of the first manipulation rod,
a second receiving part having a second inner face that is able to come into contact with the second manipulation rod and defining a second region that receives a part of the second manipulation rod, and
a first coupling part that couples the first receiving part and the second receiving part to each other,
the method comprising steps of:
manipulating the manipulation member so that the second manipulation rod moves relative to the first manipulation rod;
applying gripping force or cutting force to the target from the first acting member and the second acting member by relative motion of the second manipulation rod with respect to laterally moving the second manipulation rod relative to the second inner face in the second region defined by the second receiving part in response to the relative motion of the second manipulation rod with respect to the first manipulation rod.

12. The remote manipulation apparatus according to claim 2, wherein the first region and the second region differ in shape or size from each other.

13. The remote manipulation apparatus according to claim 3, wherein the first region and the second region differ in shape or size from each other.

14. The remote manipulation apparatus according to claim 4, wherein the first region and the second region differ in shape or size from each other.

15. The remote manipulation apparatus according to claim 12, wherein the second region has an elongated shape longer in the lateral direction when viewed in a direction along the longitudinal direction of the second manipulation rod.

16. The remote manipulation apparatus according to claim 13, wherein the second region has an elongated shape longer in the lateral direction when viewed in a direction along the longitudinal direction of the second manipulation rod.

17. The remote manipulation apparatus according to claim 14, wherein the second region has an elongated shape longer in the lateral direction when viewed in a direction along the longitudinal direction of the second manipulation rod.

18. The remote manipulation apparatus according to claim 2 further comprising a second coupling tool configured to couple the first manipulation rod and the second manipulation rod to each other in a region between the tool and the coupling tool,
wherein the second coupling tool comprises
a third receiving part having a third inner face that holds the first manipulation rod and defining a third region that receives a part of the first manipulation rod,
a fourth receiving part having a fourth inner face that is able to come into contact with the second manipulation rod, defining a fourth region that receives a part of the second manipulation rod, and configured to allow the second manipulation rod to move in the lateral direction relative to the fourth inner face in the fourth region, and
a second coupling part that couples the third receiving part and the fourth receiving part to each other, and
wherein the length of the second coupling part is shorter than the length of the first coupling part.

19. The remote manipulation apparatus according to claim 3 further comprising a second coupling tool configured to couple the first manipulation rod and the second manipulation rod to each other in a region between the tool and the coupling tool,
wherein the second coupling tool comprises
a third receiving part having a third inner face that holds the first manipulation rod and defining a third region that receives a part of the first manipulation rod,
a fourth receiving part having a fourth inner face that is able to come into contact with the second manipulation rod, defining a fourth region that receives a part of the second manipulation rod, and configured to allow the second manipulation rod to move in the lateral direction relative to the fourth inner face in the fourth region, and
a second coupling part that couples the third receiving part and the fourth receiving part to each other, and
wherein the length of the second coupling part is shorter than the length of the first coupling part.

20. The remote manipulation apparatus according to claim 4 further comprising a second coupling tool configured to couple the first manipulation rod and the second manipulation rod to each other in a region between the tool and the coupling tool,
wherein the second coupling tool comprises
a third receiving part having a third inner face that holds the first manipulation rod and defining a third region that receives a part of the first manipulation rod,
a fourth receiving part having a fourth inner face that is able to come into contact with the second manipulation rod, defining a fourth region that receives a part of the second manipulation rod, and configured to allow the second manipulation rod to move in the lateral direction relative to the fourth inner face in the fourth region, and
a second coupling part that couples the third receiving part and the fourth receiving part to each other, and
wherein the length of the second coupling part is shorter than the length of the first coupling part.
